(19) United States
(12) Patent Application Publication
(10) Pub. No.: US 2023/0156740 A1
(43) Pub. Date: May 18, 2023

(54) METHOD AND DEVICE FOR TRANSMITTING AND RECEIVING PDCCH IN WIRELESS COMMUNICATION SYSTEM

(71) Applicant: LG ELECTRONICS INC., Seoul (KR)

(72) Inventors: Hyungtae KIM, Seoul (KR); Jiwon KANG, Seoul (KR); Kyuseok KIM, Seoul (KR); Inkwon SEO, Seoul (KR)

(73) Assignee: LG ELECTRONICS INC., Seoul (KR)

(21) Appl. No.: 17/916,534

(22) PCT Filed: Apr. 1, 2021
(86) PCT No.: PCT/KR2021/004049

§ 371 Date: Sep. 30, 2022

(30) Foreign Application Priority Data
Apr. 2, 2020 (KR) 10-2020-0040275
Apr. 7, 2020 (KR) 10-2020-0042190
Oct. 5, 2020 (KR) 10-2020-0128344

(51) Int. Cl. H04W 72/232; H04L 5/00

(52) U.S. Cl. CPC H04W 72/232; H04L 5/0053; H04L 5/0094

(57) ABSTRACT

Disclosed are a method and device for transmitting and receiving a physical downlink control channel (PDCCH) in a wireless communication system. A method for receiving a PDCCH according to an embodiment of the present disclosure may comprise the steps of: receiving configuration information related to one or more control resource sets (CORESETs) from a base station; and receiving the PDCCH within the one or more CORESETs from the base station. The configuration information includes information for configuring quasi co-location (QCL) reference signals (RS) for the one or more CORESETs.

### TECHNICAL FIELD

The present disclosure relates to a wireless communication system, and in more detail, relates to a method and an apparatus of transmitting and receiving a physical downlink control channel (PDCCH) in a wireless communication system.

### BACKGROUND ART

A mobile communication system has been developed to provide a voice service while guaranteeing mobility of users. However, a mobile communication system has extended even to a data service as well as a voice service, and currently, an explosive traffic increase has caused shortage of resources and users have demanded a faster service, so a more advanced mobile communication system has been required.

The requirements of a next-generation mobile communication system at large should be able to support accommodation of explosive data traffic, a remarkable increase in a transmission rate per user, accommodation of the significantly increased number of connected devices, very low End-to-End latency and high energy efficiency. To this end, a variety of technologies such as Dual Connectivity, Massive Multiple Input Multiple Output (Massive MIMO), In-band Full Duplex, Non-Orthogonal Multiple Access (NOMA), Super wideband Support, Device Networking, etc. have been researched.

### DISCLOSURE

### Technical Problem

A technical object of the present disclosure is to provide a method and an apparatus of transmitting and receiving a physical downlink control channel (PDCCH).

In addition, an additional technical object of the present disclosure is to provide a method and an apparatus of transmitting and receiving a PDCCH based on multiple TRPs (transmission reception point).

The technical objects to be achieved by the present disclosure are not limited to the above-described technical objects, and other technical objects which are not described herein will be clearly understood by those skilled in the pertinent art from the following description.

### Technical Solution

A method of receiving a physical downlink control channel (PDCCH) in a wireless communication system according to an aspect of the present disclosure may include: receiving, from a base station, configuration information related to one or more control resource sets (CORESETs); and receiving, from the base station, the PDCCH in the one or more CORESETs. The configuration information may include information for configuring a quasi co-location (QCL) reference RS (reference signal) for the one or more CORESETs, and based on PDCCH candidates being configured to be monitored in the same time unit in a first CORESET in which a plurality of QCL reference RSs are configured and a second CORESET in which one or more QCL reference RSs are configured, the PDCCH candidates may be monitored in a first CORESET and/or a second CORESET based on a specific number of different QCL reference RSs by the terminal.

A method of transmitting a physical downlink control channel (PDCCH) in a wireless communication system according to an additional aspect of the present disclosure may include: transmitting, to a terminal, configuration information related to one or more control resource sets (CORESETs); and transmitting, to the terminal, the PDCCH in the one or more CORESETs. The configuration information may include information for configuring a quasi co-location (QCL) reference RS (reference signal) for the one or more CORESETs, and based on PDCCH candidates being configured to be monitored in the same time unit in a first CORESET in which a plurality of QCL reference RSs are configured and a second CORESET in which one or more QCL reference RSs are configured, the PDCCH candidates may be monitored in a first CORESET and/or a second CORESET based on a specific number of different QCL reference RSs by the terminal.

### Advantageous Effects

According to an embodiment of the present disclosure, it is possible to improve reliability and robustness for transmission and reception of downlink control information by transmitting and receiving a PDCCH based on multiple TRPs.

In addition, according to an embodiment of the present disclosure, when a PDCCH is repeatedly/dividedly transmitted based on multiple TRPs, even if it collides with another signal/channel and/or another control resource set and/or another search space set, a PDCCH can be stably received according to a predetermined priority.

Effects achievable by the present disclosure are not limited to the above-described effects, and other effects which are not described herein may be clearly understood by those skilled in the pertinent art from the following description.

### DESCRIPTION OF DIAGRAMS

Accompanying drawings included as part of detailed description for understanding the present disclosure provide embodiments of the present disclosure and describe technical features of the present disclosure with detailed description.

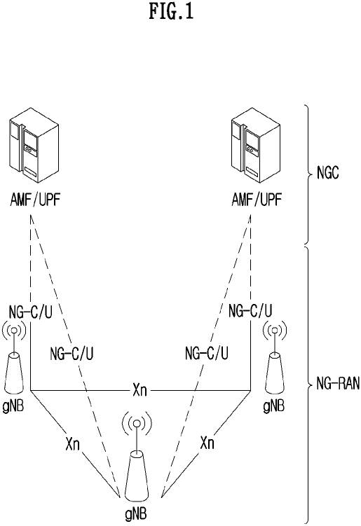

FIG. 1 illustrates a structure of a wireless communication system to which the present disclosure may be applied.

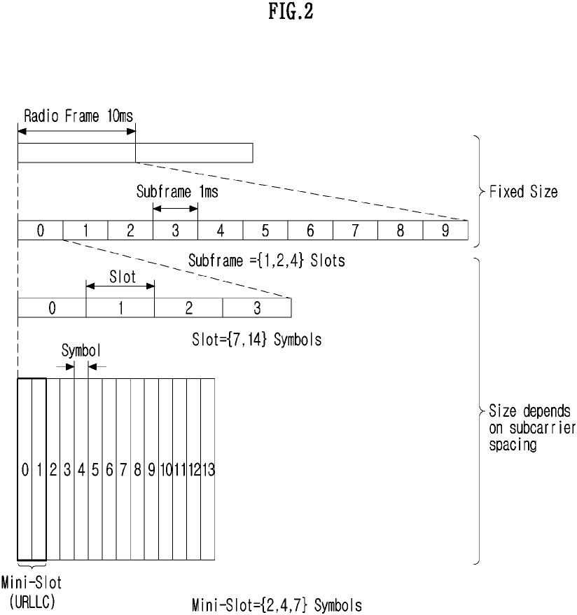

FIG. 2 illustrates a frame structure in a wireless communication system to which the present disclosure may be applied.

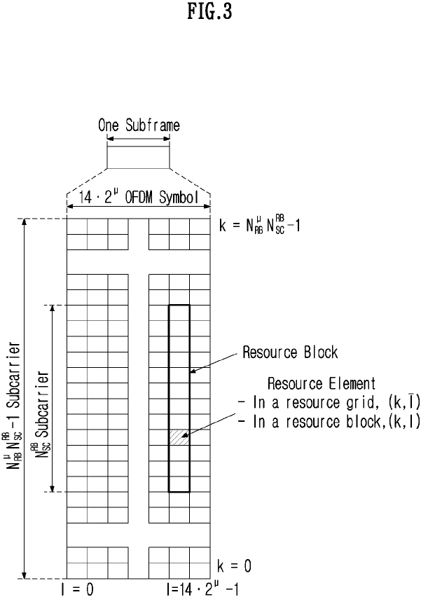

FIG. 3 illustrates a resource grid in a wireless communication system to which the present disclosure may be applied.

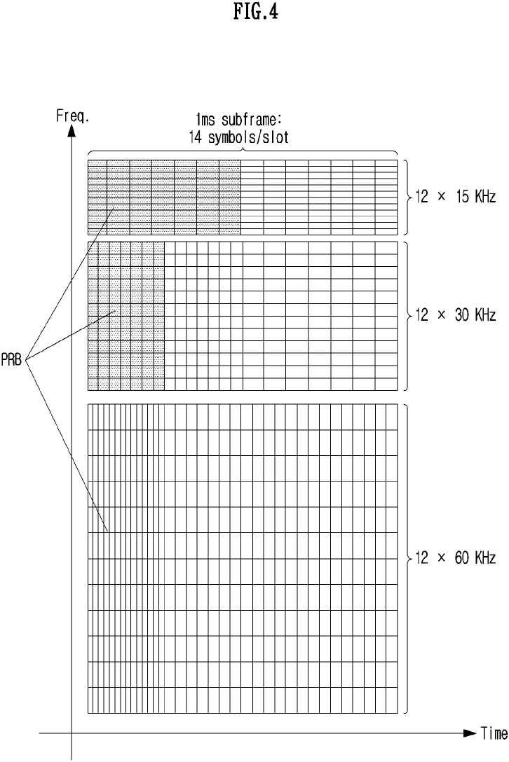

FIG. 4 illustrates a physical resource block in a wireless communication system to which the present disclosure may be applied.

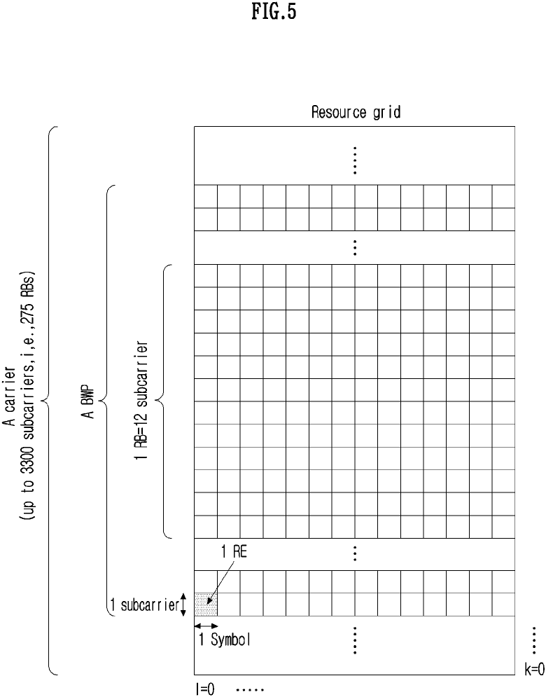

FIG. 5 illustrates a slot structure in a wireless communication system to which the present disclosure may be applied.

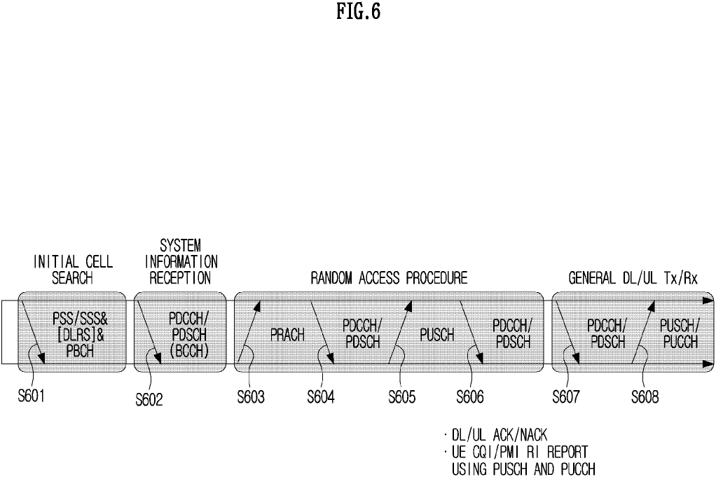

FIG. 6 illustrates physical channels used in a wireless communication system to which the present disclosure may be applied and a general signal transmission and reception method using them.

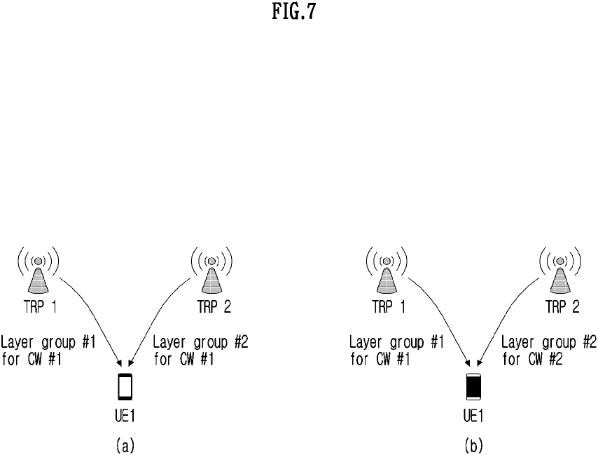

FIG. 7 illustrates a transmission method of multiple TRPs in a wireless communication system to which the present disclosure may be applied.

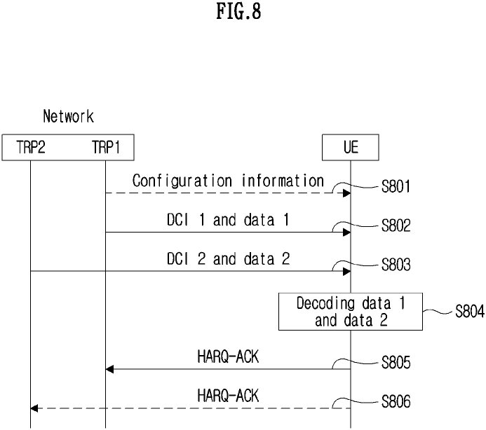

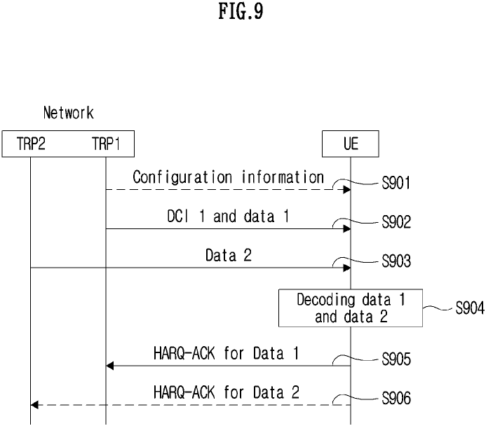

FIGS. 8 and 9 illustrates a signaling procedure between a network and a terminal for a method of transmitting and receiving a PDCCH according to an embodiment of the present disclosure.

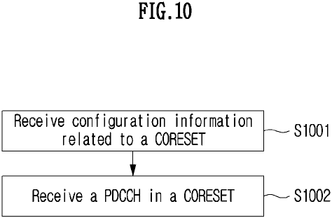

FIG. 10 is a diagram which illustrates an operation of a terminal for receiving a PDCCH according to an embodiment of the present disclosure.

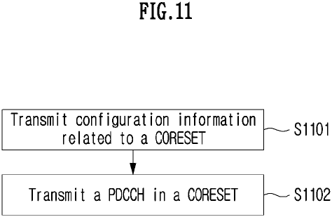

FIG. 11 is a diagram which illustrates an operation of a base station for transmitting a PDCCH according to an embodiment of the present disclosure.

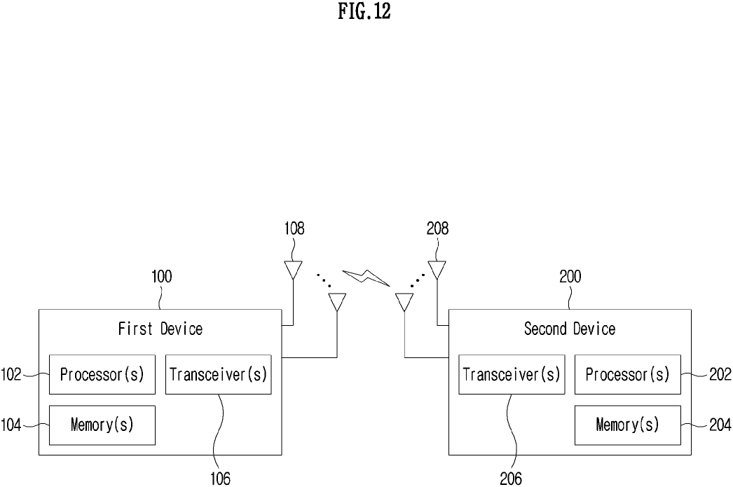

FIG. 12 illustrates a block diagram of a wireless communication device according to an embodiment of the present disclosure.

### BEST MODE

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

The present disclosure describes a wireless communication network or a wireless communication system, and an operation performed in a wireless communication network may be performed in a process in which a device (e.g., a base station) controlling a corresponding wireless communication network controls a network and transmits or receives a signal, or may be performed in a process in which a terminal associated to a corresponding wireless network transmits or receives a signal with a network or between terminals.

In the present disclosure, transmitting or receiving a channel includes a meaning of transmitting or receiving information or a signal through a corresponding channel. For example, transmitting a control channel means that control information or a control signal is transmitted through a control channel. Similarly, transmitting a data channel means that data information or a data signal is transmitted through a data channel.

Hereinafter, a downlink (DL) means a communication from a base station to a terminal and an uplink (UL) means a communication from a terminal to a base station. In a downlink, a transmitter may be part of a base station and a receiver may be part of a terminal. In an uplink, a transmitter may be part of a terminal and a receiver may be part of a base station. A base station may be expressed as a first communication device and a terminal may be expressed as a second communication device. A base station (BS) may be substituted with a term such as a fixed station, a Node B, an eNB(evolved-NodeB), a gNB(Next Generation NodeB), a BTS(base transceiver system), an Access Point(AP), a Network(5G network), an AI(Artificial Intelligence) system/module, an RSU(road side unit), a robot, a drone(UAV: Unmanned Aerial Vehicle), an AR(Augmented Reality) device, a VR(Virtual Reality) device, etc. In addition, a terminal may be fixed or mobile, and may be substituted with a term such as a UE(User Equipment), an MS(Mobile Station), a UT(user terminal), an MSS(Mobile Subscriber Station), an SS (Subscriber Station), an AMS(Advanced Mobile Station), a WT(Wireless terminal), an MTC(Machine-Type Communication) device, an M2M(Machine-to-Machine) device, a D2D(Device-to-Device) device, a vehicle, an RSU(road side unit), a robot, an AI(Artificial Intelligence) module, a drone(UAV: Unmanned Aerial Vehicle), an AR(Augmented Reality) device, a VR(Virtual Reality) device, etc.

The following description may be used for a variety of radio access systems such as CDMA, FDMA, TDMA, OFDMA, SC-FDMA, etc. CDMA may be implemented by a wireless technology such as UTRA(Universal Terrestrial Radio Access) or CDMA2000. TDMA may be implemented by a radio technology such as GSM(Global System for Mobile communications)/GPRS(General Packet Radio Service)/EDGE(Enhanced Data Rates for GSM Evolution). OFDMA may be implemented by a radio technology such as IEEE 802.11(Wi-Fi), IEEE 802.16 (WiMAX), IEEE 802-20, E-UTRA(Evolved UTRA), etc. UTRA is a part of a UMTS(Universal Mobile Telecommunications System). 3GPP(3rd Generation Partnership Project) LTE(Long Term Evolution) is a part of an E-UMTS (Evolved UMTS) using E-UTRA and LTE-A(Advanced)/LTE-A pro is an advanced version of 3GPP LTE. 3GPP NR(New Radio or New Radio Access Technology) is an advanced version of 3GPP LTE/LTE-A/LTE-A pro.

To clarify description, it is described based on a 3GPP communication system (e.g., LTE-A, NR), but a technical idea of the present disclosure is not limited thereto. LTE means a technology after 3GPP TS(Technical Specification) 36.xxx Release 8. In detail, an LTE technology in or after 3GPP TS 36.xxx Release 10 is referred to as LTE-A and an LTE technology in or after 3GPP TS 36.xxx Release 13 is referred to as LTE-A pro. 3GPP NR means a technology in or after TS 38.xxx Release 15. LTE/NR may be referred to as a 3GPP system. “xxx” means a detailed number for a standard document. LTE/NR may be commonly referred to as a 3GPP system. For a background art, a term, an abbreviation, etc. used to describe the present disclosure, matters described in a standard document disclosed before the present disclosure may be referred to. For example, the following document may be referred to.

For 3GPP LTE, TS 36.211 (physical channels and modulation), TS 36.212 (multiplexing and channel coding), TS 36.213 (physical layer procedures), TS 36.300 (overall description), TS 36.331 (radio resource control) may be referred to.

For 3GPP NR, TS 38.211 (physical channels and modulation), TS 38.212 (multiplexing and channel coding), TS 38.213 (physical layer procedures for control), TS 38.214 (physical layer procedures for data), TS 38.300 (NR and NG-RAN(New Generation-Radio Access Network) overall description), TS 38.331 (radio resource control protocol specification) may be referred to.

Abbreviations of terms which may be used in the present disclosure is defined as follows.
BM: beam management
CQI: Channel Quality Indicator
CRI: channel state information reference signal resource indicator
CSI: channel state information
CSI-IM: channel state information interference measurement
CSI-RS: channel state information reference signal
DMRS: demodulation reference signal
FDM: frequency division multiplexing
FFT: fast Fourier transform
IFDMA: interleaved frequency division multiple access
IFFT: inverse fast Fourier transform
L1-RSRP: Layer 1 reference signal received power
L1-RSRQ: Layer 1 reference signal received quality
MAC: medium access control
NZP: non-zero power
OFDM: orthogonal frequency division multiplexing
PDCCH: physical downlink control channel
PDSCH: physical downlink shared channel
PMI: precoding matrix indicator
RE: resource element
RI: Rank indicator
RRC: radio resource control
RSSI: received signal strength indicator
Rx: Reception
QCL: quasi co-location
SINR: signal to interference and noise ratio
SSB (or SS/PBCH block): Synchronization signal block (including PSS (primary synchronization signal), SSS (secondary synchronization signal) and PBCH (physical broadcast channel))
TDM: time division multiplexing
TRP: transmission and reception point
TRS: tracking reference signal
Tx: transmission
UE: user equipment
ZP: zero power

### Overall System

As more communication devices have required a higher capacity, a need for an improved mobile broadband communication compared to the existing radio access technology (RAT) has emerged. In addition, massive MTC (Machine Type Communications) providing a variety of services anytime and anywhere by connecting a plurality of devices and things is also one of main issues which will be considered in a next-generation communication. Furthermore, a communication system design considering a service/a terminal sensitive to reliability and latency is also discussed. As such, introduction of a next-generation RAT considering eMBB(enhanced mobile broadband communication), mMTC(massive MTC), URLLC(Ultra-Reliable and Low Latency Communication), etc. is discussed and, for convenience, a corresponding technology is referred to as NR in the present disclosure. NR is an expression which represents an example of a 5G RAT.

A new RAT system including NR uses an OFDM transmission method or a transmission method similar to it. A new RAT system may follow OFDM parameters different from OFDM parameters of LTE. Alternatively, a new RAT system follows a numerology of the existing LTE/LTE-A as it is, but may support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

FIG. 1 illustrates a structure of a wireless communication system to which the present disclosure may be applied.

In reference to FIG. 1, NG-RAN is configured with gNBs which provide a control plane (RRC) protocol end for a NG-RA(NG-Radio Access) user plane (i.e., a new AS(access stratum) sublayer/PDCP(Packet Data Convergence Protocol)/RLC(Radio Link Control)/MAC/PHY) and UE. The gNBs are interconnected through a Xn interface. The gNB, in addition, is connected to an NGC(New Generation Core) through an NG interface. In more detail, the gNB is connected to an AMF(Access and Mobility Management Function) through an N2 interface, and is connected to a UPF(User Plane Function) through an N3 interface.

FIG. 2 illustrates a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a basic (reference) subcarrier spacing by an integer N (or, µ). In addition, although it is assumed that a very low subcarrier spacing is not used in a very high carrier frequency, a used numerology may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| µ | Δf=2^{µ} •15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, dense-urban, lower latency and a wider carrier bandwidth are supported, and when a SCS is 60 kHz or higher, a bandwidth wider than 24.25 GHz is supported to overcome a phase noise. An NR frequency band is defined as a frequency range in two types (FR1, FR2). FR1, FR2 may be configured as in the following Table 2. In addition, FR2 may mean a millimeter wave (mmW) .

TABLE 2

| | | |
|---|---|---|
| Frequency Range designation | Corresponding frequency range | Subcarrier Spacing |
| FR1 | 410 MHz -7125 MHz | 15, 30, 60 kHz |
| FR2 | 24250 MHz -52600 MHz | 60, 120, 240 kHz |

Regarding a frame structure in an NR system, a size of a variety of fields in a time domain is expresses as a multiple of a time unit of T_{c}=⅟ (Δfₘₐₓ •N_{f}) . Here, Δfₘₐₓ is 480 •103 Hz and N_{f} is 4096. Downlink and uplink transmission is configured (organized) with a radio frame having a duration of T_{f}=⅟ (ΔfₘₐₓN_{f}/100) •T_{c}=10 ms. Here, a radio frame is configured with 10 subframes having a duration of Tₛf= (ΔfₘₐₓN_{f}/1000) •T_{c}=1 ms, respectively. In this case, there may be one set of frames for an uplink and one set of frames for a downlink. In addition, transmission in an uplink frame No. i from a terminal should start earlier by T_{TA}= (N_{TA}+N_{TA,offset}) T_{c} than a corresponding downlink frame in a corresponding terminal starts. For a subcarrier spacing configuration µ, slots are numbered in an increasing order of ns^{µ} ∈{0,..., Nₛₗₒₜ^{subframe,µ}-1} in a subframe and are numbered in an increasing order of n_{s,}_{f}^{µ}∈{0,..., Nₛₗₒₜ^{frame,µ}-1 } in a radio frame. One slot is configured with N_{symb}^{slot} consecutive OFDM symbols and N_{symb}^{slot} is determined according to CP. A start of a slot nₛ^{µ} in a subframe is temporally arranged with a start of an OFDM symbol nₛ^{µ}N_{symb}^{slot} in the same subframe. All terminals may not perform transmission and reception at the same time, which means that all OFDM symbols of a downlink slot or an uplink slot may not be used. Table 3 represents the number of OFDM symbols per slot (N_{symb}^{slot}) , the number of slots per radio frame (Nₛₗₒₜ^{frame,µ}) and the number of slots per subframe (Nₛₗₒₜ^{subframe,µ}) in a normal CP and Table 4 represents the number of OFDM symbols per slot, the number of slots per radio frame and the number of slots per subframe in an extended CP.

TABLE 3

| µ | N_{symb}^{slot} | Nₛₗₒₜ^{frame,µ} | Nₛₗₒₜ^{subframe,µ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| µ | N_{symb}^{slot} | Nₛₗₒₜ^{frame,µ} | Nₛₗₒₜ^{subframe,}^{µ} |
|---|---|---|---|
| 2 | 12 | 40 | 4 |

FIG. 2 is an example on µ=2 (SCS is 60 kHz), 1 subframe may include 4 slots referring to Table 3. 1 subframe={1,2,4} slot shown in FIG. 2 is an example, the number of slots which may be included in 1 subframe is defined as in Table 3 or Table 4. In addition, a mini-slot may include 2, 4 or 7 symbols or more or less symbols. Regarding a physical resource in a NR system, an antenna port, a resource grid, a resource element, a resource block, a carrier part, etc. may be considered. Hereinafter, the physical resources which may be considered in an NR system will be described in detail.

First, in relation to an antenna port, an antenna port is defined so that a channel where a symbol in an antenna port is carried can be inferred from a channel where other symbol in the same antenna port is carried. When a large-scale property of a channel where a symbol in one antenna port is carried may be inferred from a channel where a symbol in other antenna port is carried, it may be said that 2 antenna ports are in a QC/QCL(quasi co-located or quasi co-location) relationship. In this case, the large-scale property includes at least one of delay spread, doppler spread, frequency shift, average received power, received timing.

FIG. 3 illustrates a resource grid in a wireless communication system to which the present disclosure may be applied.

In reference to FIG. 3, it is illustratively described that a resource grid is configured with N_{RB}^{µ}N_{sc}^{RB} subcarriers in a frequency domain and one subframe is configured with 14 •2^{µ} OFDM symbols, but it is not limited thereto. In an NR system, a transmitted signal is described by OFDM symbols of 2^{µ}N_{symb}^{(µ)} and one or more resource grids configured with N_{RB}^{µ}N_{sc}^{RB} subcarriers. Here, N_{RB}^{µ}≤N_{RB}^{max,µ}. The N_{RB}^{max,µ} represents a maximum transmission bandwidth, which may be different between an uplink and a downlink as well as between numerologies. In this case, one resource grid may be configured per µ and antenna port p. Each element of a resource grid for µ and an antenna port p is referred to as a resource element and is uniquely identified by an index pair (k,l′) . Here, k=0,..., N_{RB}^{µ}N_{sc}^{RB}-1 is an index in a frequency domain and l′=0, ..., 2^{µ}N_{symb}^{(µ)}-1 refers to a position of a symbol in a subframe. When referring to a resource element in a slot, an index pair (k,l) is used. Here, l=0, ..., N_{symb}^{µ}-1. A resource element (k,l′) for µ and an antenna port p corresponds to a complex value, a_{k,1′}^{(p,µ)}. When there is no risk of confusion or when a specific antenna port or numerology is not specified, indexes p and µ may be dropped, whereupon a complex value may be a_{k,1′}^{(p)} or a_{k,1′}. In addition, a resource block (RB) is defined as N_{sc}^{RB}=12 consecutive subcarriers in a frequency domain.

Point A plays a role as a common reference point of a resource block grid and is obtained as follows.
offsetToPointA for a primary cell (PCell) downlink represents a frequency offset between point A and the lowest subcarrier of the lowest resource block overlapped with a SS/PBCH block which is used by a terminal for an initial cell selection. It is expressed in resource block units assuming a 15 kHz subcarrier spacing for FR1 and a 60 kHz subcarrier spacing for FR2.
absoluteFrequencyPointA represents a frequency-position of point A expressed as in ARFCN (absolute radiofrequency channel number).

Common resource blocks are numbered from 0 to the top in a frequency domain for a subcarrier spacing configuration µ. The center of subcarrier 0 of common resource block 0 for a subcarrier spacing configuration µ is identical to ‘point A’. A relationship between a common resource block number n_{CRB}^{µ} and a resource element (k,l) for a subcarrier spacing configuration µ in a frequency domain is given as in the following Equation 1.

$${n}_{C R B}^{μ} = \left⌊\frac{k}{{N}_{s c}^{R B}}\right⌋$$

In Equation 1, k is defined relatively to point A so that k=0 corresponds to a subcarrier centering in point A. Physical resource blocks are numbered from 0 to N_{BWP,i}^{size,µ}-1 in a bandwidth part (BWP) and i is a number of a BWP. A relationship between a physical resource block n_{PRB} and a common resource block n_{CRB} in BWP i is given by the following Equation 2.

$${n}_{C R B}^{μ} = {n}_{P R B}^{μ} + {N}_{B W P , i}^{s t a r t , μ}$$

N_{BWP,i}^{start,µ} is a common resource block that a BWP starts relatively to common resource block 0.

FIG. 4 illustrates a physical resource block in a wireless communication system to which the present disclosure may be applied. And, FIG. 5 illustrates a slot structure in a wireless communication system to which the present disclosure may be applied.

In reference to FIG. 4 and FIG. 5, a slot includes a plurality of symbols in a time domain. For example, for a normal CP, one slot includes 7 symbols, but for an extended CP, one slot includes 6 symbols.

A carrier includes a plurality of subcarriers in a frequency domain. An RB (Resource Block) is defined as a plurality of (e.g., 12) consecutive subcarriers in a frequency domain. A BWP(Bandwidth Part) is defined as a plurality of consecutive (physical) resource blocks in a frequency domain and may correspond to one numerology (e.g., an SCS, a CP length, etc.). A carrier may include a maximum N (e.g., 5) BWPs. A data communication may be performed through an activated BWP and only one BWP may be activated for one terminal. In a resource grid, each element is referred to as a resource element (RE) and one complex symbol may be mapped.

In an NR system, up to 400 MHz may be supported per component carrier (CC). If a terminal operating in such a wideband CC always operates turning on a radio frequency (FR) chip for the whole CC, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. By considering it, a base station may indicate a terminal to operate only in a partial bandwidth, not in a full bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured to a terminal. For example, a BWP occupying a relatively small frequency domain may be configured in a PDCCH monitoring slot, and a PDSCH indicated by a PDCCH may be scheduled in a greater BWP. Alternatively, when UEs are congested in a specific BWP, some terminals may be configured with other BWP for load balancing. Alternatively, considering frequency domain inter-cell interference cancellation between neighboring cells, etc., some middle spectrums of a full bandwidth may be excluded and BWPs on both edges may be configured in the same slot. In other words, a base station may configure at least one DL/UL BWP to a terminal associated with a wideband CC. A base station may activate at least one DL/UL BWP of configured DL/UL BWP(s) at a specific time (by L1 signaling or MAC CE(Control Element) or RRC signaling, etc.). In addition, a base station may indicate switching to other configured DL/UL BWP (by L1 signaling or MAC CE or RRC signaling, etc.). Alternatively, based on a timer, when a timer value is expired, it may be switched to a determined DL/UL BWP. Here, an activated DL/UL BWP is defined as an active DL/UL BWP. But, a configuration on a DL/UL BWP may not be received when a terminal performs an initial access procedure or before a RRC connection is set up, so a DL/UL BWP which is assumed by a terminal under these situations is defined as an initial active DL/UL BWP.

FIG. 6 illustrates physical channels used in a wireless communication system to which the present disclosure may be applied and a general signal transmission and reception method using them.

In a wireless communication system, a terminal receives information through a downlink from a base station and transmits information through an uplink to a base station. Information transmitted and received by a base station and a terminal includes data and a variety of control information and a variety of physical channels exist according to a type/a usage of information transmitted and received by them.

When a terminal is turned on or newly enters a cell, it performs an initial cell search including synchronization with a base station or the like (S601) . For the initial cell search, a terminal may synchronize with a base station by receiving a primary synchronization signal (PSS) and a secondary synchronization signal (SSS) from a base station and obtain information such as a cell identifier (ID), etc. After that, a terminal may obtain broadcasting information in a cell by receiving a physical broadcast channel (PBCH) from a base station. Meanwhile, a terminal may check out a downlink channel state by receiving a downlink reference signal (DL RS) at an initial cell search stage.

A terminal which completed an initial cell search may obtain more detailed system information by receiving a physical downlink control channel (PDCCH) and a physical downlink shared channel (PDSCH) according to information carried in the PDCCH (S602) .

Meanwhile, when a terminal accesses to a base station for the first time or does not have a radio resource for signal transmission, it may perform a random access (RACH) procedure to a base station (S603 to S606). For the random access procedure, a terminal may transmit a specific sequence as a preamble through a physical random access channel (PRACH) (S603 and S605) and may receive a response message for a preamble through a PDCCH and a corresponding PDSCH (S604 and S606). A contention based RACH may additionally perform a contention resolution procedure.

A terminal which performed the above-described procedure subsequently may perform PDCCH/PDSCH reception (S607) and PUSCH(Physical Uplink Shared Channel)/PUCCH(physical uplink control channel) transmission (S608) as a general uplink/downlink signal transmission procedure. In particular, a terminal receives downlink control information (DCI) through a PDCCH. Here, DCI includes control information such as resource allocation information for a terminal and a format varies depending on its purpose of use.

Meanwhile, control information which is transmitted by a terminal to a base station through an uplink or is received by a terminal from a base station includes a downlink/uplink ACK/NACK(Acknowledgement/Non-Acknowledgement) signal, a CQI(Channel Quality Indicator), a PMI(Precoding Matrix Indicator), a RI(Rank Indicator), etc. For a 3GPP LTE system, a terminal may transmit control information of the above-described CQI/PMI/RI, etc. through a PUSCH and/or a PUCCH.

Table 5 represents an example of a DCI format in an NR system.

TABLE 5

| DCI Format | Use |
|---|---|
| 0_0 | Scheduling of a PUSCH in one cell |
| 0_1 | Scheduling of one or multiple PUSCHs in one cell, or indication of cell group downlink feedback information to a UE |
| 0_2 | Scheduling of a PUSCH in one cell |
| 1_0 | Scheduling of a PDSCH in one DL cell |
| 1_1 | Scheduling of a PDSCH in one cell |
| 1_2 | Scheduling of a PDSCH in one cell |

In reference to Table 5, DCI formats 0_0, 0_1 and 0_2 may include resource information (e.g., UL/SUL(Supplementary UL), frequency resource allocation, time resource allocation, frequency hopping, etc.), information related to a transport block(TB) (e.g., MCS(Modulation Coding and Scheme), a NDI(New Data Indicator), a RV(Redundancy Version), etc.), information related to a HARQ(Hybrid - Automatic Repeat and request) (e.g., a process number, a DAI(Downlink Assignment Index), PDSCH-HARQ feedback timing, etc.), information related to multiple antennas (e.g., DMRS sequence initialization information, an antenna port, a CSI request, etc.), power control information (e.g., PUSCH power control, etc.) related to scheduling of a PUSCH and control information included in each DCI format may be pre-defined. DCI format 0_0 is used for scheduling of a PUSCH in one cell. Information included in DCI format 0_0 is CRC (cyclic redundancy check) scrambled by a C-RNTI(Cell Radio Network Temporary Identifier) or a CS-RNTI(Configured Scheduling RNTI) or a MCS-C-RNTI(Modulation Coding Scheme Cell RNTI) and transmitted.

DCI format 0_1 is used to indicate scheduling of one or more PUSCHs or configure grant (CG) downlink feedback information to a terminal in one cell. Information included in DCI format 0_1 is CRC scrambled by a C-RNTI or a CS-RNTI or a SP-CSI-RNTI(Semi-Persistent CSI RNTI) or a MCS-C-RNTI and transmitted.

DCI format 0_2is used for scheduling of a PUSCH in one cell. Information included in DCI format 0_2is CRC scrambled by a C-RNTI or a CS-RNTI or a SP-CSI-RNTI or a MCS-C-RNTI and transmitted.

Next, DCI formats 1_0, 1_1 and 1_2 may include resource information (e.g., frequency resource allocation, time resource allocation, VRB(virtual resource block)-PRB(physical resource block) mapping, etc.), information related to a transport block(TB) (e.g., MCS, NDI, RV, etc.), information related to a HARQ (e.g., a process number, DAI, PDSCH-HARQ feedback timing, etc.), information related to multiple antennas (e.g., an antenna port, a TCI(transmission configuration indicator), a SRS(sounding reference signal) request, etc.), information related to a PUCCH (e.g., PUCCH power control, a PUCCH resource indicator, etc.) related to scheduling of a PDSCH and control information included in each DCI format may be pre-defined.

DCI format 1_0 is used for scheduling of a PDSCH in one DL cell. Information included in DCI format 1_0 is CRC scrambled by a C-RNTI or a CS-RNTI or a MCS-C-RNTI and transmitted.

DCI format 1_1 is used for scheduling of a PDSCH in one cell. Information included in DCI format 1_1 is CRC scrambled by a C-RNTI or a CS-RNTI or a MCS-C-RNTI and transmitted.

DCI format 1_2 is used for scheduling of a PDSCH in one cell. Information included in DCI format 1_2 is CRC scrambled by a C-RNTI or a CS-RNTI or a MCS-C-RNTI and transmitted.

### Quasi-Co Locaton QCL

An antenna port is defined so that a channel where a symbol in an antenna port is transmitted can be inferred from a channel where other symbol in the same antenna port is transmitted. When a property of a channel where a symbol in one antenna port is carried may be inferred from a channel where a symbol in other antenna port is carried, it may be said that 2 antenna ports are in a QC/QCL (quasi co-located or quasi co-location) relationship.

Here, the channel property includes at least one of delay spread, doppler spread, frequency/doppler shift, average received power, received timing/average delay, or a spatial RX parameter. Here, a spatial Rx parameter means a spatial (Rx) channel property parameter such as an angle of arrival.

A terminal may be configured at list of up to M TCI-State configurations in a higher layer parameter PDSCH-Config to decode a PDSCH according to a detected PDCCH having intended DCI for a corresponding terminal and a given serving cell. The M depends on UE capability.

Each TCI-State includes a parameter for configuring a quasi co-location relationship between ports of one or two DL reference signals and a DM-RS(demodulation reference signal) of a PDSCH.

A quasi co-location relationship is configured by a higher layer parameter qcl-Type1 for a first DL RS and qcl-Type2 for a second DL RS (if configured). For two DL RSs, a QCL type is not the same regardless of whether a reference is a same DL RS or a different DL RS.

A QCL type corresponding to each DL RS is given by a higher layer parameter qcl-Type of QCL-Info and may take one of the following values.
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

For example, when a target antenna port is a specific NZP CSI-RS, it may be indicated/configured that a corresponding NZP CSI-RS antenna port is quasi-colocated with a specific TRS with regard to QCL-Type A and is quasi-colocated with a specific SSB with regard to QCL-Type D. A terminal received such indication/configuration may receive a corresponding NZP CSI-RS by using a doppler, delay value measured in a QCL-TypeA TRS and apply a Rx beam used for receiving QCL-TypeD SSB to reception of a corresponding NZP CSI-RS.

UE may receive an activation command by MAC CE signaling used to map up to 8 TCI states to a codepoint of a DCI field ‘Transmission Configuration Indication’.

### Operation Related to Multi-TRPs

A coordinated multi point (CoMP) scheme refers to a scheme in which a plurality of base stations effectively control interference by exchanging (e.g., using an X2 interface) or utilizing channel information (e.g., RI/CQI/PMI/LI(layer indicator), etc.) fed back by a terminal and cooperatively transmitting to a terminal. According to a scheme used, a CoMP may be classified into joint transmission(JT), coordinated Scheduling(CS), coordinated Beamforming(CB), dynamic Point Selection(DPS), dynamic Point Blocking(DPB), etc.

M-TRP transmission schemes that M TRPs transmit data to one terminal may be largely classified into i) eMBB M-TRP transmission, a scheme for improving a transfer rate, and ii) URLLC M-TRP transmission, a scheme for increasing a reception success rate and reducing latency.

In addition, with regard to DCI transmission, M-TRP transmission schemes may be classified into i) M-TRP transmission based on M-DCI(multiple DCI) that each TRP transmits different DCIs and ii) M-TRP transmission based on S-DCI(single DCI) that one TRP transmits DCI. For example, for S-DCI based M-TRP transmission, all scheduling information on data transmitted by M TRPs should be delivered to a terminal through one DCI, it may be used in an environment of an ideal BackHaul (ideal BH) where dynamic cooperation between two TRPs is possible.

For TDM-based URLLC M-TRP transmission, scheme ¾ is under discussion for standardization. Specifically, scheme 4 means a scheme in which one TRP transmits a transport block (TB) in one slot, and it has an effect of increasing a data reception probability through the same TB received from multiple TRPs in multiple slots. In contrast, scheme 3 means a scheme in which one TRP transmits a TB through several consecutive OFDM symbols (i.e., a symbol group), and several TRPs may be configured to transmit the same TB through different symbol groups in one slot.

In addition, UE may recognize PUSCH (or PUCCH) scheduled by DCI received in different control resource sets(CORESETs) (or CORESETs belonging to different CORESET groups) as PUSCH (or PUCCH) transmitted to different TRPs or may recognize PDSCH (or PDCCH) from different TRPs. In addition, the below-described method for UL transmission (e.g., PUSCH/PUCCH) transmitted to different TRPs may be applied equivalently to UL transmission (e.g., PUSCH/PUCCH)transmitted to different panels belonging to the same TRP.

In addition, MTRP-URLLC may mean that the same transport block (TB) is transmitted using different layers/time/frequency by M-TRP. It can be assumed that a UE configured with the MTRP-URLLC transmission method is indicated with multiple TCI state(s) by DCI, and data received using a QCL RS of each TCI state is the same TB. On the other hand, MTRP-eMBB may mean that different TBs are transmitted using different layer/time/frequency by M-TRP. It can be assumed that a UE configured with the MTRP-eMBB transmission method is indicated with several TCI state(s) by DCI, and data received using a QCL RS of each TCI state are different TBs. In this regard, as a UE separates and uses an RNTI configured for the MTRP-URLLC and an RNTI configured for the MTRP-eMBB, it may be decided/determined whether a corresponding M-TRP transmission is the URLLC transmission or the eMBB transmission. That is, when CRC masking of DCI received by a UE is performed using an RNTI configured for the MTRP-URLLC, this may correspond to URLLC transmission, and when CRC masking of DCI is performed using an RNTI configured for the MTRP-eMBB, this may correspond to eMBB transmission.

Hereinafter, a CORESET group ID described/mentioned in the present disclosure may mean an index/identification information (e.g., an ID, etc.) for distinguishing a CORESET for each TRP/panel. In addition, a CORESET group may be a group/union of CORESET distinguished by an index/identification information (e.g., an ID)/the CORESET group ID, etc. for distinguishing a CORESET for each TRP/panel. In an example, a CORESET group ID may be specific index information defined in a CORESET configuration. In this case, a CORESET group may be configured/indicated/defined by an index defined in a CORESET configuration for each CORESET. Additionally/alternatively, a CORESET group ID may mean an index/identification information/an indicator, etc. for distinguishment/identification between CORESETs configured/associated with each TRP/panel. Hereinafter, a CORESET group ID described/mentioned in the present disclosure may be expressed by being substituted with a specific index/specific identification information/a specific indicator for distinguishment/identification between CORESETs configured/associated with each TRP/panel. The CORESET group ID, i.e., a specific index/specific identification information/a specific indicator for distinguishment/identification between CORESETs configured/associated with each TRP/panel may be configured/indicated to a terminal through higher layer signaling (e.g., RRC signaling)/L2 signaling (e.g., MAC-CE)/L1 signaling (e.g., DCI), etc. In an example, it may be configured/indicated so that PDCCH detection will be performed per each TRP/panel in a unit of a corresponding CORESET group (i.e., per TRP/panel belonging to the same CORESET group). Additionally/alternatively, it may be configured/indicated so that uplink control information (e.g., CSI, HARQ-A/N(ACK/NACK), SR(scheduling request)) and/or uplink physical channel resources (e.g., PUCCH/PRACH/SRS resources) are separated and managed/controlled per each TRP/panel in a unit of a corresponding CORESET group (i.e., per TRP/panel belonging to the same CORESET group). Additionally/alternatively, HARQ A/N(process/retransmission) for PDSCH/PUSCH, etc. scheduled per each TRP/panel may be managed per corresponding CORESET group (i.e., per TRP/panel belonging to the same CORESET group).

For example, ControlResourceSet information element (IE), a higher layer parameter, is used to configure a time/frequency CORESET (control resource set). In an example, the CORESET may be related to detection and reception of downlink control information. The ControlResourceSet IE may include a CORESET-related ID (e.g., controlResourceSetID) / an index of a CORESET pool for a CORESET (e.g., CORESETPoolIndex) / a time/frequency resource configuration of a CORESET / CORESET-related TCI information, etc. In an example, an index of a CORESET pool (e.g., CORESETPoolIndex) may be configured as 0 or 1. In the description, a CORESET group may correspond to a CORESET pool and a CORESET group ID may correspond to a CORESET pool index (e.g., CORESETPoolIndex).

Hereinafter, a method for improving reliability in Multi-TRP will be described.

As a transmission and reception method for improving reliability using transmission in a plurality of TRPs, the following two methods may be considered.

FIG. 7 illustrates a method of multiple TRPs transmission in a wireless communication system to which the present disclosure may be applied.

In reference to FIG. 7(a), it is shown a case in which layer groups transmitting the same codeword(CW)/transport block(TB) correspond to different TRPs. Here, a layer group may mean a predetermined layer set including one or more layers. In this case, there is an advantage that the amount of transmitted resources increases due to the number of a plurality of layers and thereby a robust channel coding with a low coding rate may be used for a TB, and additionally, because a plurality of TRPs have different channels, it may be expected to improve reliability of a received signal based on a diversity gain.

In reference to FIG. 7(b), an example that different CWs are transmitted through layer groups corresponding to different TRPs is shown. Here, it may be assumed that a TB corresponding to CW #1 and CW #2 in the drawing is identical to each other. In other words, CW #1 and CW #2 mean that the same TB is respectively transformed through channel coding, etc. into different CWs by different TRPs. Accordingly, it may be considered as an example that the same TB is repetitively transmitted. In case of FIG. 7(b), it may have a disadvantage that a code rate corresponding to a TB is higher compared to FIG. 7(a). However, it has an advantage that it may adjust a code rate by indicating a different RV (redundancy version) value or may adjust a modulation order of each CW for encoded bits generated from the same TB according to a channel environment.

According to methods illustrated in FIG. 7(a) and FIG. 7(b) above, probability of data reception of a terminal may be improved as the same TB is repetitively transmitted through a different layer group and each layer group is transmitted by a different TRP/panel. It is referred to as a SDM (Spatial Division Multiplexing) based M-TRP URLLC transmission method. Layers belonging to different layer groups are respectively transmitted through DMRS ports belonging to different DMRS CDM groups.

In addition, the above-described contents related to multiple TRPs are described based on an SDM (spatial division multiplexing) method using different layers, but it may be naturally extended and applied to a FDM (frequency division multiplexing) method based on a different frequency domain resource (e.g., RB/PRB (set), etc.) and/or a TDM (time division multiplexing) method based on a different time domain resource (e.g., a slot, a symbol, a sub-symbol, etc.).

### Method of Transmitting and Receiving a PDCCH For Supporting Multi-TRPs M-TRPs Transmission and Reception

The present disclosure applies the proposed method assuming cooperative transmission/reception between 2 TRPs for convenience of description, but it can be extended and applied even in an environment of 3 or more multi-TRPs, and also in a multi-panel environment. Different TRPs may be recognized by a UE as different Transmission Configuration Indication (TCI) states. That is, a UE receives/transmits data/DCI/UCI using TCI state 1 means that it receives/transmits data/DCI/UCI from/to TRP 1.

The proposal of the present disclosure may be utilized in a situation in which MTRPs cooperatively transmits a PDCCH (the same PDCCH is repeatedly transmitted or dividedly transmitted), and some proposals may also be utilized in a situation in which MTRPs cooperatively transmits a PDSCH or receives a PUSCH/PUCCH cooperatively.

In addition, in the present disclosure, the meaning that a plurality of base stations (i.e., MTRP) repeatedly transmit the same PDCCH may mean that the same DCI is transmitted through multiple PDCCH candidates, and may mean that a plurality of base stations repeatedly transmit the same DCI. The same DCI may mean two DCI having the same DCI format/size/payload. Alternatively, even if payloads of two DCI are different, if a scheduling result is the same, it can be said that the two DCIs are the same DCI. For example, a slot/symbol location of data and a slot/symbol location of an ACK (acknowledgement)/NACK (non-acknowledgement) is relatively determined based on a reception time of DCI by a time domain resource allocation (TDRA) field of DCI. Here, if DCI received at time n and DCI received at time n+1 inform a UE of the same scheduling result, TDRA fields of two DCI are different, and as a result, DCI payloads are inevitably different. The number of repetitions R may be directly indicated to a UE by a base station or may be mutually promised. Alternatively, even if payloads of two DCI are different and scheduling results are not the same, if a scheduling result of one DCI is a subset of a scheduling result of the other DCI, it may be said to be the same DCI. For example, when the same data is TDMed and repeatedly transmitted N times, DCI 1 received before the first data indicates N repetitions of data, and DCI 2 received after the first data and before the second data indicates N-1 repetitions of data. Scheduling data of DCI 2 is a subset of scheduling data of DCI 1, and since both DCI are scheduling for the same data, in this case, they can also be referred to as the same DCI.

In addition, in the present disclosure, the meaning that a plurality of base stations (i.e., MTRP) dividedly transmit the same PDCCH means that one DCI is transmitted through one PDCCH candidate, but TRP 1 transmits some resources in which the PDCCH candidate is defined, and TRP 2 transmits the remaining resources. One PDCCH candidate divided and transmitted by a plurality of base stations (i.e., MTRP) may be recognized/indicated to a UE through configuration information of a base station.

The proposals of the present disclosure can be extended to various channels such as PUSCH/PUCCH/PDSCH/PDCCH.

In NR, in order to provide flexibility for a PDCCH control region, it is not required that a PDCCH control region is configured over a system bandwidth. Accordingly, a time/frequency control resource set (CORESET) for searching for downlink control information (DCI) (or for monitoring PDCCH) may be configured. A CORESET may be divided into a common CORESET and a UE-specific CORESET. A common CORESET may be configured for multiple UEs in one cell, and a UE-specific CORESET may mean a PDCCH control region defined for a specific UE. The number of CORESETs may be limited to three per BWP, including common CORESETs and UE-specific CORESETs. A search space (set) means a set of PDCCH candidates. In other words, a search space (set) may mean a set of PDCCH candidates decoded at different aggregation levels. Each search space (set) may be associated with one CORESET, and one CORESET may be associated with a plurality of search spaces (set). A UE monitors a set of PDCCH candidates in one or more CORESETs on an activated DL BWP on each activated serving cell in which PDCCH monitoring is configured according to corresponding search space sets. Here, monitoring includes the meaning of decoding each PDCCH candidate according to monitored DCI formats.

Problem 1: According to the current NR system, when a PDCCH candidate and an SSB/LTE-CRS resource collide in the same time/frequency resource, a UE prioritizes an SSB/LTE-CRS resource and drops a PDCCH candidate without attempting blind detection (BD).

In an MTRP PDCCH transmission scheme, multiple TRPs may transmit the same DCI by TDM at different times or by FDM at different frequencies. For example, in a case of TDM (/FDM), TRP 1 transmits PDCCH candidate 1 in t1 time unit (e.g., one or more symbols) (/f1 frequency unit (e.g., one or more resource blocks)) and TRP 2 may transmit PDCCH candidate 2 in t2 time unit (/f2 frequency unit). A UE can distinguish between a PDCCH candidate transmitted by TRP 1 and a PDCCH candidate transmitted by TRP 2. For example, based on a TCI state (or QCL-related information) used to receive each PDCCH candidate (e.g., a TCI state configured in a CORESET including each PDCCH candidate) is different, a UE can distinguish PDCCH candidates (transmitted from different TRPs).

Here, if some candidates among PDCCH candidates transmitting the same DCI collide with an SSB/LTE-CRS and the rest do not collide, according to the conventional method, a UE drops only the collided PDCCH candidates (i.e., a UE does not perform BD) and does not drop the non-collided PDCCH candidates. However, due to this method, in an MTRP PDCCH transmission scheme, a PDCCH candidate of TRP 1 may be dropped and a PDCCH candidate of TRP 2 may not be dropped. In this case, since only one TRP is transmitted in a PDCCH, an effect of improving reliability through MTRP PDCCH transmission cannot be obtained.

### Embodiment 1-1

In order to solve the above problem, a PDCCH candidate collided with an SSB/LTE-CRS is not dropped, and puncturing (or rate matching) may be performed on a collided resource. That is, a UE may assume that puncturing/rate matching is performed for an SSB/LTE-CRS resource. As a result, a UE can increase a PDCCH (or DCI) reception success rate by receiving a PDCCH candidate punctured from a collision resource and an intact PDCCH candidate that does not collide with an SSB/LTE-CRS.

In addition, in an MTRP PDCCH transmission scheme, when one TRP transmits the same DCI by TDM at different times or repeatedly transmits the same DCI by FDM at different frequencies (i.e., one TRP transmits the same DCI multiple times), a UE may drop a PDCCH candidate having a collision according to the conventional method. For example, when the same DCI is repeatedly transmitted by TDM, the same DCI may be transmitted four times over t1 time unit, t2 time unit, t3 time unit, and t4 time unit. TRP 1 may transmit PDCCH candidates 1 and 3 in t1 time unit and t3 time unit, respectively, and TRP 2 may transmit PDCCH candidates 2 and 4 in t2 time unit and t4 time unit, respectively. Here, if PDCCH candidate 1 collides with an SSB/CRS and PDCCH candidate 3 does not collide, at least one of PDCCH candidates repeatedly transmitted by TRP 1 can be completely transmitted. Accordingly, a UE may drop PDCCH candidate 1. In the above description, for example, a DCI transmission timing such as t1 time unit, t2 time unit, t3 time unit, and t4 time unit may mean one or more symbols. However, if all PDCCH candidates transmitted by one TRP collide with an SSB/CRS (for example, in the above case, if both PDCCH candidates 1 and 3 collide with an SSB/CRS), a UE may not drop at least one candidate among them. And, puncturing/rate matching is performed on the resource in which the collision occurs, so that PDCCH transmission can be performed from the corresponding TRP.

Alternatively, if N (N may be fixed to a specific value, or may be configured to a UE by a base station) or more PDCCH candidates collide with an SSB/CRS, a UE may drop N-1 candidates among N or more PDCCH candidates according to the existing method, and the remaining candidates may be punctured/rate matched.

In the above description, a resource unit in which puncturing/rate matching may be determined as one of, for example, a resource element (RE) / a resource element group (REG) / a resource element group bundle (REG bundle) / a control channel element (CCE) . A base station may indicate to a UE a resource unit in which puncturing/rate matching is performed. Alternatively, a resource unit in which puncturing/rate matching is performed may be predefined.

### Embodiment 1-2

When a plurality of base stations (i.e., MTRP) dividedly transmit the same PDCCH, a UE aggregates a PDCCH candidate (e.g., aggregation level=x) transmitted by TRP 1 and a PDCCH candidate (e.g., aggregation level=y) transmitted by TRP 2 to generate one PDCCH candidate (e.g., aggregation level=x+y) and performs BD. That is, a UE receives some fragments from TRP1 among several fragments constituting one PDCCH candidate, and receives the remaining fragments from TRP2. In this case, if even one of PDCCH candidates transmitted by each TRP collides with an SSB/CRS and is dropped (i.e., if any fragment constituting one PDCCH candidate is dropped), a UE cannot fully receive one PDCCH candidate (e.g., aggregation level=x+y). Therefore, in this case, if even one of PDCCH candidates transmitted by each TRP collides with an SSB/CRS and is dropped, it is preferable to drop all the remaining PDCCH candidates. As a result, a UE may not perform BD for all the corresponding PDCCH candidates.

The above-described embodiment 1-2 can be equally applied even when a plurality of base stations repeatedly transmit the same PDCCH. That is, if any one of the same PDCCHs transmitted from different TRPs collides with an SSB/CRS and is dropped, the remaining PDCCHs may also be dropped.

### Embodiment 1-3

It may be assumed that an SSB/CRS transmitted by TRP 1 is SSB1/CRS1, and it may be assumed that a PDCCH candidate transmitted by TRP 1 is PDCCH candidate 1. It may be assumed that an SSB/CRS transmitted by TRP 2 is SSB2/CRS2, and it may be assumed that a PDCCH candidate transmitted by TRP 2 is PDCCH candidate2. If TRP 1 and TRP 2 are different cells, a UE can distinguish SSBs/CRSs transmitted by two cells using PCID (Physical Cell ID), and can distinguish PDCCH candidates transmitted by two cells through QCL reference RS information of TCI states configured for receiving the corresponding PDCCH candidates. That is, when a QCL reference RS of a TCI state configured for reception of PDCCH candidate 1 is an SSB transmitted by cell 1, it can be seen that PDCCH candidate 1 is transmitted through cell 1. Alternatively, if a QCL reference RS of a TCI state configured for reception of PDCCH candidate 1 is not an SSB transmitted by cell 1, but the QCL reference RS is configured with an SSB transmitted by cell 1 as a higher-level QCL reference RS, it can be seen that PDCCH candidate 1 was transmitted through cell 1.

When SSB1/CRS1 and PDCCH candidate 2 collide, even if a transmission TRP is different, PDCCH candidate2 may be dropped/punctured/rate matched. Since an SSB/CRS is the most basic RS that an NR UE/LTE UE must receive, in order to minimize interference received by SSB1/CRS1, it is preferable that drop/puncturing/rate matching of PDCCH candidate2 is conservative. This is the same for a case of collision between SSB2/CRS2 and PDCCH candidate 1.

However, if SSB1/CRS1 and PDCCH candidate 2 collide with PDCCH candidate 2, and if PDCCH candidate 2 is dropped/punctured/rate matched, there may be a problem in that the probability of fully transmitting/receiving PDCCH candidate2 is lowered. This is because drop/puncturing/rate matching is applied to PDCCH candidate2 upon collision not only for SSB2/CRS2 but also for SSB1/CRS1. As a result, there is a possibility that the number of PDCCH candidates transmitted by TRP 2 will drastically decrease. Therefore, in order to prevent this, when SSB1/CRS1 and PDCCH candidate 2 collide, the collision may be ignored and transmission of PDCCH candidate 2 may be performed without drop/puncturing/rate matching. This is the same for a case of collision between SSB2/CRS2 and PDCCH candidate 1.

For the two opposite operations (i.e., when a PDCCH candidate transmitted by one TRP and an SSB/CRS transmitted by the other TRP collide, a base station performs drop/puncturing/rate matching on the PDCCH candidate), a base station may indicate one of the two operations to a UE through higher layer signaling (e.g., RRC/MAC control element (CE)).

### Embodiment 1-4

In Embodiments 1-1/ 1-2/ 1-3, etc., when a PDCCH candidate collides with an SSB/CRS, various methods of drop/rate matching/puncturing a PDCCH candidate have been proposed. In addition to a collision with an SSB/CRS, when a PDCCH candidate and a UL channel are configured at the same time and/or when a PDCCH candidate and URLLC data are configured at the same time, various methods of the first embodiment (e.g., embodiments 1-1/ 1-2/ 1-3, etc.) may be extended and applied.

For example, when a PDCCH candidate is configured in a DL/UL flexible symbol and the corresponding symbol is used for a UL channel, a PDCCH candidate configured in the corresponding symbol by giving priority to a UL channel may be dropped/rate matched/punctured by applying the Embodiment 1. Alternatively, when URLLC data is transmitted/received in a symbol in which a PDCCH candidate is configured, a PDCCH candidate may be dropped/rate matched/punctured by applying the Embodiment 1, giving priority to the URLLC data.

Whether the above-described Embodiments 1-1/1-2/1-3/1-4 is applied may be applied only to a specific aggregation level. For example, when an aggregation level is high, even if some resources of a candidate are punctured/rate matched, since a coding rate is still low, decoding is highly likely to be successful. Accordingly, when an aggregation level is high, the Embodiments 1-1/1-2/1-3/1-4 may be applied. For example, when an aggregation level is higher than a specific level (e.g., 4, 8, etc.), the above Embodiments 1-1/1-2/1-3/1-4 may be applied. Alternatively, when an aggregation level is low, the Embodiments 1-1/1-2/1-3/1-4 may be applied. For example, when an aggregation level is lower than a specific level (e.g., 4, 8, etc.), the above Embodiments 1-1/1-2/1-3/1-4 may be applied. Alternatively, a base station may configure/indicate a terminal an aggregation level to which the Embodiments 1-1/1-2/1-3/1-4 are applied.

In addition, whether or not the above-described Embodiments 1-1/1-2/1-3/1-4 are applied may be applied according to an amount (size)/ratio of resources in which a collision occurs. For example, if a collision occurs in x% (eg, x=1) of resources constituting a PDCCH candidate, puncturing/rate matching of only the corresponding resource is more efficient than dropping the whole. Alternatively, if a collision occurs in less than x REs/REGs/REG bundles/CCEs among resources constituting a PDCCH candidate, puncturing/rate matching of only the corresponding resource is more efficient than dropping the whole. Here, the x value may be indicated/configured by a base station to a UE.

In addition, whether the above-described Embodiments 1-1/1-2/1-3/1-4 are applied may be determined according to whether a resource in which a collision occurs is a resource in which the PDCCH DMRS is transmitted. If a DMRS is punctured/rate matched, channel estimation is difficult, so when a DMRS resource collides, a PDCCH candidate is dropped, otherwise, puncturing/rate matching may be applied. Because a DMRS directly affects channel estimation performance, if a collision occurs in a DMRS RE, all candidates may be conservatively dropped. On the other hand, when a collision occurs in a PDCCH resource other than a DMRS, puncturing/rate matching is preferably performed.

Alternatively, when a DMRS resource collide, a RE/REG/REG bundle/CCE including the corresponding DMRS may be punctured/rate matched. On the other hand, if there is a collision in a resource other than a DMRS, only the corresponding resource may be puncturing/rate matching. This is because a UE performs channel estimation in units of REG bundles/CCEs, so that when a DMRS is punctured/rate matched, channel estimation performance of a REG bundle/CCE in which a DMRS is located is affected. Therefore, in this case, it is preferable that a REG bundle/CCE be punctured/rate matched.

### Embodiment 1-5

In the above-described Embodiments 1-1/ 1-2/ 1-3, etc., a method of processing a PDCCH candidate when a PDCCH candidate collides with a CRS/SSB has been proposed. In Embodiment 1-5, in order to prevent collision between a PDCCH candidate and a CRS/SSB in advance, a method of generating a PDCCH candidate only from CCEs that do not collide with a CRS/SSB is proposed.

Among CCEs constituting one search space, a hashing function is re-defined for the remaining CCEs except for CCEs including REs that collide with a CRS/SSB, based on this, a PDCCH candidate may be reconstructed. Equation 3 below is a hashing function that determines which CCE is constituted of a PDCCH candidate for a search space in the NR system.

According to the current standard, for a search space set s to which CORESET p is associated, a CCE index for a PDCCH candidate m_{s,n_CI} of an aggregation level (AL) L of a search space set within a slot n_{s,f}^{µ} for an activated DL BWP of a serving cell corresponding to a carrier indicator field n_CI(n_{CI}) may be defined based on the hash function of Equation 3 below.

$$\begin{matrix}L ⋅ \left\{\left({Y}_{p , {n}_{s , f}^{μ}} + \left⌊\frac{{m}_{s , {n}_{C I}} ⋅ {N}_{\text{CCE} , p}}{L ⋅ {M}_{s , max}^{\left(L\right)}}\right⌋ + {n}_{C I}\right) m o d \left⌊{N}_{\text{CCE,} p} / L\right⌋\right\} + i \\ - \text{CSS:} {Y}_{p , {n}_{s , f}^{μ}} = 0 ; \\ - \text{USS,:} {Y}_{p , {n}_{s , f}^{μ}} = \left({A}_{p} ⋅ {Y}_{p , {n}_{s , f}^{μ} - 1}\right) mod D , {Y}_{p , - 1} = {n}_{\text{RNTI}} \neq 0 , {A}_{p} = \\ 39827 \left(p m o d 3 = 0\right) , {A}_{p} = 39829 \left(p m o d 3 = 1\right) , {A}_{p} = 39839 \\ \left(p m o d 3 = 2\right) , D = 65537 ;\end{matrix}$$

In Equation 3, a CSS refers to a common search space, and a USS refers to a UE specific search space. i=0,...,L-1. N_{CCE,p} is the number of CCEs in CORESET p, and is numbered from 0 to N_{CCE,p}-1.

When a PDCCH is configured as a carrier indicator field by a parameter for cross-carrier scheduling configuration (i.e., CrossCarrierSchedulingConfig) for a monitored serving cell, n_CI(n_{CI}) is a carrier indicator field value. Otherwise, for any CSS, n_CI=0.

m_{s,n_CI}=0, ..., M_{s,n_CI}^{(L)}-1. Here, M_{s,n_CI}^{(L)} is the number of PDCCH candidates configured to be monitored by a UE for an aggregation level L of a search space set s for a serving cell corresponding to n_CI(n_{CI}).

For any CSS, M_{s,max}^{(L)} =M_{s,0}^{(L)}. For USS, M_{s,max}^{(L)} is a maximum value of M_{s,n_CI}^{(L)} over all configured n_CI (n_{CI}) values for a CCE aggregation level L of a search space set s.

An RNTI used for n_{RNTI} is a C-RNTI.

In Equation 3, N_{CCE,p} means the total number of CCEs constituting a CORESET associated with a search space. When a CRS/SSB and CCEs constituting CORESET collide at a specific time, N_{CCE,p} may be configured as the number of CCEs other than the colliding CCE. In addition, a CCE index may also be re-indexed (re-numbering / index updating) except for the colliding CCE. For example, when a CORESET includes 10 CCEs (e.g., CCE0, CCE1, ..., CCE9), if CCE 1 collides with a CRS/SSB (i.e., collides with a CRS/SSB in one or more REs in CCE1), CCE1 may be excluded from indexing. In addition, CCE 2 following CCE1 to CCE 9 are indexed again as CCE 1 to CCE 8, and by configuring N_{CCE,p}=9, a PDCCH candidate may be configured through a hashing function.

Problem 2: In the current NR system, when two CORESETs are configured in the same time resource (e.g., one or more identical symbols, etc.) and QCL type D RSs of the two CORESETs are different (this is called a CORESET collision in the present disclosure), according to the priority, a UE receives only one CORESET (i.e., a CORESET with a high priority) and drops the rest (i.e., a UE does not monitor the corresponding CORESET). A configuration for one or more TCI states may be included in a CORESET configuration, and a configuration for each TCI state may include information on a QCL type and reference signal(s) having a QCL relationship with a PDCCH DMRS port monitored on the corresponding CORESET.

Specifically, the priorities will be described. A CORESET associated with a common search space (CSS) has a higher priority than a UE specific search space (USS). And, when a CORESET associated with a CSS is configured in several cells, a cell having a lower cell index has a higher priority. And, when multiple CORESETs associated with a CSS are configured in one cell, a CORESET associated with a CSS having a lower search space ID (identity) has a higher priority. If only CORESETs associated with a USS are configured at the same time, a CORESET associated with a USS having a lower search space ID has a higher priority. Additionally, when the same PDCCH is repeatedly transmitted or the same PDCCH is divided and transmitted, when a corresponding CORESET collides with an existing CORESET, additional priority may be defined and a specific CORESET may has a higher priority.

### Embodiment 2-1

When the same PDCCH is repeatedly transmitted by TDM, a corresponding CORESET (i.e., when the same PDCCH is repeatedly transmitted by TDM to different CORESETs) may collide with an existing CORESET. For example, the same PDCCH is repeatedly transmitted in t1 time unit (e.g., one or more symbols) and t2 time resource through CORESET 1 and CORESET 2, respectively, and CORESET 1 and CORESET 3 corresponding to an existing CORESET (i.e., to which repeated transmission is not applied) may collide. In this case, even if CORESET 1 is dropped, there is one more opportunity to transmit the same PDCCH at time t2, so the side effect due to the drop is not large. Therefore, when a CORESET corresponding to repeated transmission collides with an existing CORESET (i.e., to which repeated transmission is not applied), a UE may drop a CORESET corresponding to repeated transmission. Alternatively, when considering an intention of a base station to repeatedly transmit, CORESET 1 may be considered more important than CORESET 3 because it is a CORESET used to transmit a PDCCH with high reliability. Therefore, since an operation of dropping COERSET 1 is an operation opposite to an intention of a base station, it may be more preferable to drop an existing CORESET (i.e., to which repeated transmission is not applied) (CORESET in the above example). One of the two opposite operations (i.e., which CORESET to drop when a CORESET corresponding to repeated transmission and an existing CORESET (i.e., to which repeated transmission is not applied) collide) may be configured/indicated by a base station to a UE.

The proposed priority may be applied prior to considering a cell index in an existing priority or may be applied prior to considering a search space set ID. Alternatively, it may be applied first before considering a priority between CSS/USS. For example, according to the above proposal method between CORESET 1 related to repeated PDCCH transmission and CORESET 2 to which repeated PDCCH transmission is not applied, any one CORESET may be dropped. In addition, when a non-dropped CORESET and another CORESET 3 collide, a priority between the non-dropped CORESET and another CORESET 3 may be determined in consideration of a priority between a cell index and/or search space set ID and/or CSS/USS as described above.

When the same PDCCH is repeatedly transmitted by FDM, a priority similar to the above proposal may be introduced. For example, the same PDCCH is repeatedly transmitted in frequency unit f1 (e.g., one or more resource blocks) and frequency unit f2 through CORESET 1 and CORESET 2, respectively, and CORESET ½ and CORESET 3 corresponding to an existing CORESET (i.e., to which repeated transmission is not applied) may collide in time unit t1. In this case, CORESET 3 to which repeated transmission is not applied may be dropped, and conversely, CORESET ½ to which repeated transmission is applied may be dropped.

Alternatively, different priorities may be introduced according to repeated TDM/FDM transmission of the same PDCCH. For example, in a case of repeated TDM transmission of the same PDCCH, an existing CORESET may have a higher priority over a CORESET corresponding to repeated transmission (i.e., a CORESET corresponding to repeated transmission is dropped), and in a case of repeated FDM transmission, a CORESET corresponding to repeated transmission may have a higher priority over an existing CORESET (i.e., a CORESET to which repeated transmission is not applied). Or vice versa.

When the same PDCCH is divided and transmitted by TDM (divided transmission), a corresponding CORESET may collide with an existing CORESET. For example, the same PDCCH is transmitted in t1 time unit (e.g., one or more symbols) and t2 time resource through CORESET 1 and CORESET 2, respectively, and CORESET 1 and CORESET 3 corresponding to an existing CORESET (i.e., to which repeated transmission/ divided transmission is not applied) may collide. In this case, if CORESET 1 is dropped, a UE cannot generate one PDCCH by aggregating two PDCCHs even if the same PDCCH is transmitted in the t2 time resource. Therefore, unlike the case of repeatedly transmitting the same PDCCH, if CORESET 1 is dropped, even if CORESET 2 is received, a UE cannot fully receive one PDCCH. Therefore, if a CORESET corresponding to a dividedly transmitted PDCCH collides with an existing CORESET (i.e., to which repeated transmission/ divided transmission is not applied), an existing CORESET may be dropped. Alternatively, it may be more preferable to drop a CORESET corresponding to a dividedly transmitted PDCCH by giving a higher priority to an existing CORESET. A base station may configure/indicated to a UE one of the two opposite operations (i.e., when a CORESET corresponding to divided transmission and an existing CORESET (i.e., to which repeated transmission/divided transmission is not applied) collide, which CORESET should be dropped).

The proposed priority may be applied prior to considering a cell index in an existing priority or may be applied prior to considering a search space set ID. Alternatively, it may be applied first before considering a priority between CSS/USS.

When the same PDCCH is repeatedly transmitted by FDM, a priority similar to the above proposal may be introduced. For example, the same PDCCH is repeatedly transmitted in frequency unit f1 (e.g., one or more resource blocks) and frequency unit f2 through CORESET 1 and CORESET 2, respectively, and CORESET ½ and CORESET 3 corresponding to an existing CORESET (i.e., to which repeated transmission is not applied) may collide in time unit t1. In this case, CORESET 3 to which divided transmission is not applied may be dropped, and conversely, CORESET ½ to which divided transmission is applied may be dropped.

Alternatively, different priorities may be introduced according to TDM/FDM. For example, in a case of TDM transmission, an existing CORESET may have a higher priority over a CORESET corresponding to divided transmission, and in a case of FDM transmission, a CORESET corresponding to a divided transmission PDCCH may have a higher priority over an existing CORESET. Or vice versa.

The CORESET configured for repeatedly/divided transmission of the same PDCCH as described above may be one of the following CORESETs.
One CORESET to which a plurality of TCI states are associated may be configured to a UE to repeatedly/dividedly transmit the same PDCCH. Here, the corresponding CORESET may be defined as a CORESET for repeatedly/dividedly transmission of the same PDCCH.
A plurality of CORESETs to which one TCI state is associated may be configured to a UE to repeatedly/dividedly transmit the same PDCCH. Here, each of the corresponding CORESETs may be defined as a CORESET for repeatedly/dividedly transmission of the same PDCCH.
One CORESET to which one TCI state is associated may be configured to a UE to repeatedly/dividedly transmit the same PDCCH. The corresponding CORESET may be linked/associated with a search space set associated with (one or more) TCI state. Here, the corresponding CORESET may be defined as a CORESET for repeatedly/dividedly transmission of the same PDCCH.

### Embodiment 2-2

A base station may group a plurality of CORESETs configured to a UE to configure/indicate CORESET group (pool) information for a UE. And, when collision occurs between CORESETs, a priority between CORESETs may be determined based on CORESET group (pool) information. For example, a CORESET existing in a specific CORESET group (e.g., a CORESET group with a lower group id (identity)) may have a higher priority than a CORESET of another CORESET group (e.g., a CORESET group with a higher group id). Alternatively, as an example of the reverse order, a CORESET of a CORESET group having a higher group id may have a high priority. In the above proposal, a group id is an example of identification information for distinguishing a CORESET group (pool), it may be substituted with a term such as a CORESET pool index (or ID).

For example, a plurality of TRPs (e.g., TRP 1 and TRP 2) may transmit a PDCCH to a UE by configuring different CORESETs, respectively. Here, a CORESET used by TRP i may be configured as CORESET group i. Through this, when CORESETs of TRP 1 and TRP 2 collide, a UE may prioritize a CORESET of a specific TRP (i.e., a specific CORESET group) to perform PDCCH monitoring.

The proposed priority may be applied prior to considering a cell index in an existing priority or may be applied prior to considering a search space set ID. Alternatively, it may be applied first before considering a priority between CSS/USS. For example, according to the above proposed method, any one CORESET may be dropped between CORESET 1 belonging to CORESET group (pool) 1 and CORESET 2 belonging to CORESET group (pool) 2. In addition, when a non-dropped CORESET and another CORESET 3 collide, a priority between the non-dropped CORESET and another CORESET 3 may be determined in consideration of a priority between a cell index and/or search space set ID and/or CSS/USS as described above.

Meanwhile, when two different TCI states are configured in one CORESET (in the same meaning, when other two QCL reference RSs of the same QCL type are configured in one CORESET), if a corresponding CORESET collides with another CORESET in the same time unit (e.g., OFDM symbol) (i.e., if QCL type D reference RSs of two CORESETs are different and are configured to receive at one moment (/same timing/same occasion) (e.g., the same one or more symbols)), it operates according to the following proposal.

For convenience of description, a CORESET in which corresponding two different TCI states are configured is referred to as CORESET A (referred to as A-0, A-1, A-2, ... n case of a plurality of CORESETs). In addition, the other CORESET that collision occurs is referred to as CORESET B (referred to as B-0, B-1, B-2, B-3, ... in case of a plurality of CORESETs). Hereinafter, for convenience of description, it is assumed that one TCI state is configured in CORESET B. However, even when a plurality of TCI states are configured in CORESET B, the proposed method described below is equivalently applied.

For example, two TCI states of CORESET A are mapped to different frequency domains of CORESET A, and through this, two TRPs may repeatedly transmit or dividedly transmit a PDCCH by FDM. On the other hand, if CORESET A is used for TDM-based MTRP PDCCH transmission, even if two TCI states are configured in CORESET A, a PDCCH of CORESET A is transmitted/received with only one TCI state at a time. As a result, there is only one TCI state used for reception in CORESET A at a specific time, like an existing CORESET B. Therefore, in this case, CORESET A is treated like an existing CORESET B, and a UE may select a CORESET according to an existing priority rule.

### Embodiment 2-3

In the current standardization, a UE can simultaneously receive two CORESETs in which the TCI state is configured differently by using two receiving panels at one moment (/ same timing/ same occasion) (e.g., one or more symbols) (for convenience of description, it is called 2 Rx panel UE in the specification), a method of grouping CORESETs by CORESET pool index and applying an existing priority rule within a corresponding CORESET group to determine a received CORESET is under discussion. However, this discussion is being conducted under the assumption that one TCI state is defined in one CORESET. If two TCI states are defined as in CORESET A, the following UE operation may be considered. A UE may first select a CORESET by applying an existing priority rule for each CORESET pool, and as a result, the following method is proposed for Case 1 or Case 2. An operation of selecting a CORESET by applying an existing priority rule for each CORESET pool may mean that an operation of selecting a CORESET of the highest priority from among CORESETs corresponding to (configured with) the same CORESET pool index based on a priority rule is performed for each CORESET pool. That is, for example, a UE may determine a CORESET of the highest priority based on a priority rule among CORESETs corresponding to (configured with) CORESET pool 1, and similarly, may determine a CORESET of the highest priority based on a priority rule among CORESETs corresponding to (configured with) CORESET pool 2.

Case 1: A collision between CORESET A configured with CORESET pool index = 0 (CORESET configured with two different TCI states) and CORESET B configured with CORESET pool index = 1 (CORESET configured with one TCI state)

If Case 1 occurs as a result of selecting a CORESET by applying a priority rule for each CORESET pool, a UE should receive a CORESET with receive beams (i.e., QCL type D reference RS configured in the TCI state) corresponding to a total of three TCI states. In this case, a UE may receive a CORESET by selecting a reception beam in the following manners. That is, a UE performs monitoring/blind detection on PDCCH candidates of the selected CORESET with the selected beam.

Hereinafter, reception of a CORESET using a TCI state may mean that monitoring/blind detection is performed on PDCCH candidates of a corresponding CORESET by using (applying) a reception beam (or QCL type D reference RS) configured in a corresponding TCI state.

Alt 1: A UE may receive CORESET A using one specific TCI state configured in CORESET A, and may receive CORESET B using a TCI state of CORESET B. The specific one TCI state may be promised/defined as the first TCI state or the second (or last) TCI state among two TCI states, or may be promised/defined as a TCI state corresponding to the lowest (or highest) TCI state ID (identity). As a result, a UE can still receive one CORESET for each CORESET pool.

However, since only one TCI state of CORESET A is used, a PDCCH of CORSET A is changed to STRP transmission rather than MTRP transmission. Specifically, CORESET A was originally configured to operate in such a way that two TRPs repeatedly transmit or dividedly transmit the same DCI, however in the above case, one TRP corresponding to the selected TCI state should transmit all of PDCCHs configured to be transmitted in both TRPs. As a result, a UE should receive a PDCCH that should be received using a TCI state not selected in CORESET A using the selected TCI state. For example, in a case of repeated transmission of the same PDCCH, a UE should receive a PDCCH using different TCI states, respectively, however in the above case, a UE may receive repeated PDCCHs using only one TCI state. Alternatively, in this case, a PDCCH to be transmitted by a TRP corresponding to an unselected TCI state may not transmitted, and only the PDCCH to be transmitted by a TRP corresponding to a selected TCI state may be transmitted. As a result, a UE may not receive a PDCCH to be received using an unselected TCI state, however may receive only PDCCH to be received using a selected TCI state.

As one TCI state is selected in the CORESET A, there is no need to limit to apply a method of operating as STRP PDCCH transmission/reception to Alt 1 of Case 1 above, and if one TCI state is selected in CORESET A for other cases and other Alts to be described later, a method of STRP PDCCH transmission/reception may be performed in the same manner.

Alt 2: A UE may receive CORESET A using two TCI states in CORESET A, and may not receive CORESET B. Since CORESET A is used for PDCCH transmission with high reliability, it needs to be transmitted with a higher priority than CORESET B. Therefore, according to Alt 2 above, a UE may receive an MTRP PDCCH of CORESET A and not CORESET B. In other words, a UE may receive a CORESET in which a larger number of TCI states are configured, and may not receive (drop) another (i.e., a smaller number of TCI states) CORESET.

Alt 3: Contrary to Alt 2, a UE may receive only CORESET B and not CORESET A. In this case, if CORESET C to which the same QCL type D RS as CORESET B and one TCI state are configured exists among CORESETs that can be simultaneously received at the same moment (/same timing/same occasion) with CORESET pool index = 0, a UE may receive CORESET C instead of CORESET A. That is, a UE may receive CORESET B and CORESET C together by using/applying the same beam/same QCL type D RS. Here, if there are a plurality of CORESETs in which one TCI state is configured among CORESETs that can be simultaneously received at the same moment (/same timing/same occasion) with CORESET pool index = 0, a UE may receive a CORESET determined according to an existing priority rule instead of CORESET A.

Case 2: A collision between CORESET A-0 configured with CORESET pool index = 0 (CORESET configured with two different TCI states) and CORESET A-1 configured with CORESET pool index = 1 (CORESET configured with two different TCI states)

If Case 2 occurs as a result of selecting a CORESET by applying a priority rule for each CORESET pool, a UE should receive a CORESET with receive beams (i.e., QCL type D reference RS configured in the TCI state) corresponding to a total of four TCI states. In this case, a UE may receive a CORESET by selecting a reception beam in the following manners. That is, a UE performs monitoring/blind detection on PDCCH candidates of the selected CORESET with the selected beam.

Alt 1: A UE may receive CORESET A-0 using one specific TCI state configured in CORESET A-0, and may receive CORESET A-1 using one specific TCI state configured in CORESET A-1. The specific one TCI state may be promised/defined as the first TCI state or the second (or last) TCI state among two TCI states, or may be promised/defined as a TCI state corresponding to the lowest (or highest) TCI state ID (identity). As a result, a UE can still receive one CORESET for each CORESET pool.

However, since only one TCI state of CORESET A-0/A-1 is used, a PDCCH of CORSET A-0/A-1 is changed to STRP transmission rather than MTRP transmission. Therefore, the operation for STRP transmission of a PDCCH described above in Case 1 may be performed identically.

Alt 2. A UE may receive a specific CORESET among CORESETs A-0 and A-1 and may not receive the other CORESET. The specific one CORESET may be selected by an existing priority rule (as described in Problem 2 above, for example, a CSS has a higher priority than a USS, and a CSS of a cell having a lower cell index may have a higher priority among CSSs of a plurality of cells. Also, a CORESET with a lower Search Space ID may have a higher priority in the same cell) that does not distinguish between CORESET pools. That is, a UE may not consider a CORESET pool to which each CORESET corresponds/be included in order to determine one specific CORESET. Alternatively, simply, a it may be promised/defined that a UE receives a CORESET corresponding to the lowest CORESET pool index among CORESETs A-0 and A-1.

Case 1/Case 2 dealt with a case where CORESETs corresponding to different COERSET pools collide, however a UE operation for a case where CORESETs with the same CORESET pool collide (or if there is a collision between CORESETs to which a CORESET pool is not configured) will be described below.

Case 3: A collision of CORESET A (CORESET configured with two different TCI states) and CORESET B (CORESET configured with one TCI state) configured with the same CORESET pool index (or to which a CORESET pool index is not configured)

Alt 1: A UE may receive CORESET A using one specific TCI state configured in CORESET A, and may receive CORESET B using one specific TCI state configured in CORESET B. However, since only one TCI state of CORESET A is used, a PDCCH of CORSET A is changed to STRP transmission rather than MTRP transmission. Therefore, the operation for STRP transmission of a PDCCH described above in Case 1 may be performed identically.

This operation may be considered together with an existing priority rule (i.e., search space type > cell ID > search space ID). For example, the operation of Alt 1 of Case 3 above may be applied to two remaining (selected) CORESETs with the first priority and the second priority according to an existing priority rule.

Alt 2: Since CORESET A is used for PDCCH transmission with high reliability, it needs to be transmitted with a higher priority than CORESET B. Accordingly, a UE may receive the MTRP PDCCH of CORESET A and not CORESET B. In other words, a UE may receive a CORESET in which a larger number of TCI states are configured, and may not receive (drop) another (i.e., a smaller number of TCI states) CORESET.

This operation may be considered together with an existing priority rule (i.e., search space type > cell ID > search space ID). For example, the operation of Alt 1 of Case 3 above may be applied to two remaining (selected) CORESETs with the first priority and the second priority according to an existing priority rule.

Alt 3: Contrary to Alt 2, a UE may receive only CORESET B and not receive CORESET A. In this case, if CORESET C to which one TCI state are configured exists among CORESETs that can be simultaneously received at the same moment (/same timing/same occasion) with CORESET pool index = 0, a UE may receive CORESET C instead of CORESET A. Alternatively, if there are a plurality of CORESETs in which the same QCL type D RS as CORESET B and one TCI state are configured among CORESETs that can be simultaneously received at the same moment (/same timing/same occasion) with CORESET pool index = 0, a UE may receive a CORESET determined according to an existing priority rule instead of CORESET A.

Case 4: A collision of CORESET A-0 (CORESET configured with two different TCI states) and CORESET A-1 (CORESET configured with two different TCI states) configured with the same CORESET pool index (or to which a CORESET pool index is not configured)

Alt 1: A UE may receive CORESET A-0 using one specific TCI state configured in CORESET A-0, and may receive CORESET A-1 using one specific TCI state configured in CORESET A-1. The specific one TCI state may be promised/defined as the first TCI state or the second (or last) TCI state among two TCI states, or may be promised/defined as a TCI state corresponding to the lowest (or highest) TCI state ID (identity). However, since only one TCI state of each CORESET is used, a PDCCH of each CORSET is changed to STRP transmission instead of MTRP transmission. Therefore, the operation for STRP transmission of a PDCCH described above in Case 1 may be performed identically.

This operation may be considered together with an existing priority rule (i.e., search space type > cell ID > search space ID). For example, the operation of Alt 1 of Case 4 above may be applied to two remaining (selected) CORESETs with the first priority and the second priority according to an existing priority rule.

Alt 2: A UE may receive only one specific CORESET among CORESETs A-0, A-1, and not receive the remaining CORESETs. The specific one CORESET may be selected according to an existing priority rule (e.g., search space type > cell ID > search space ID). Alternatively, it may simply be promised/defined as receiving a CORESET corresponding to the lowest CORESET index/ID.

The above proposal is an operation assuming a two-panel UE. If a UE can receive only one CORESET using one panel at one moment (/same timing/ same occasion), one CORESET may be selected according to an existing priority rule. Here, when 2 TCI states are configured in the selected CORESET, a UE may receive the selected CORESET by using one specific TCI state (TCI state is selected according to the proposed method). In this case, STRP PDCCH transmission/reception is performed instead of MTRP PDCCH transmission/reception.

Alternatively, whether a CORESET in which multi-TCI states are configured or a CORESET in which a single-TCI state is configured may be considered in addition to an existing priority rule. For example, it may be applied by changing an existing priority rule (search space type > cell ID > search space ID) to a revised priority rule (search space type > cell ID > number of TCIs in one CORESET > search space ID). For example, a CORESET associated with a CSS may have a higher priority than a USS. And, when a CORESET associated with a CSS is configured in several cells, a cell having a low cell index may have a higher priority. In addition, when multiple CORESETs related to a CSS are configured in one cell, a CORESET in which a large number of TCIs are configured may have a higher priority. In addition, if multiple CORESETs related to a CSS are configured in one cell, but the number of TCIs configued in each CORESET is the same, a CORESET associated with a CSS having a low search space ID (identity) has a higher priority. Accordingly, if 2 TCI states are configured in the selected CORESET, a UE may receive the CORESET using one specific TCI state.

Whether a UE supports transmission/reception based on a plurality of panels (and/or the number of supportable panels) may be reported to a base station as UE capability information.

In the above proposal, when CORESET A (a CORESET in which two different TCI states are configured) and A collide or A and B (a CORESET in which one TCI state is configure) collide, it was assumed that QCL type D reference RSs (or a higher RS associated with a QCL source QCL RS of a QCL type D reference RS) of the two CORESETs in which a collision occurred are different from each other. If QCL type D reference RSs between two CORESETs are the same or overlap, even if a collision occurs, two-panel UE can simultaneously receive all the CORESETs, so the problem 2 does not occur.

In the above proposals (e.g., embodiments 2-1, 2-1, 2-3 (Alt methods for each case)), a specific proposal method may be applied according to a case in which a specific condition is satisfied. Alternatively, more flexibly, a base station may configure a specific proposed method in advance with RRC signaling, etc., and indicate/configure a UE to use the scheme.

In the collision problem, a method of selecting one specific TCI state in CORESET A (i.e., Alt 1 of Case 1/2/3/4) was proposed. Whether to apply this method may be determined according to whether a transmission method of a PDCCH corresponding to CORESET A is repeated transmission, divided transmission, or SFN transmission.

Here, in a case of a PDCCH SFN transmission method, two TRPs transmit the same PDCCH with the same DMRS port or different DMRS ports in the same time frequency domain (resource). A UE performs DMRS channel estimation using both a TCI state corresponding to TRP 1 and a TCI state corresponding to TRP 2. In a case of the same DMRS port, a UE estimates one DMRS port channel using both TCI states. When each TRP configures/transmits a different DMRS port, each TCI state is used to estimate a channel of each DMRS port, and then, two channels are appropriately combined to estimate one SFN channel.

For example, in a case of repeated PDCCH transmission, a STRP repeated transmission method may be used by applying Alt 1 of Case 1/2/3/4. And, when divided transmission of a PDCCH, by applying Alt 2/3 of Case 1/2/3/4 instead of Alt 1 of Case 1/2/ 2/3/4, a UE may drop CORESET B or CORESET A. Even in a PDCCH SFN transmission method, by applying Alt 1 of Case 1/2/3/4, it may be operated by falling back to an existing STRP PDCCH SFN method.

If CORESET A is configured to repeatedly/dividedly transmit a PDCCH in a TDM method, a 2 Rx panel UE can receive both PDCCHs of two CORESETs even in collision between CORESET A and CORESET A, or collision between CORESET A and CORESET B. However, in a case of a one-panel UE (i.e., a UE that cannot simultaneously receive two channels having different QCL type D), it is still not possible to simultaneously receive PDCCHs of two CORESETs. For example, if a first TCI state of CORESET A and a TCI state of CORESET B are configured to different QCL type D at a specific time, a PDCCH cannot be simultaneously received. In this case, if there is an intersection among QCL type D of two CORESETs having collision, a UE may receive both CORESETs (PDCCH monitoring) using the TCI state of QCL type D corresponding to the intersection.

For example, it is assumed that CORESET A is repeatedly transmitted using TCI states 1, 2, 1, 2 in slots 1, 2, 3, 4, TCI state 1 is configured with QCL type D RS = TRS 1, TCI state 2 is configured with QCL type D RS = TRS 2. In addition, it is assumed that a collision with CORESET B occurs in slot 2 and CORESET B is configured with QCL type D RS = TRS 1. In this case, in slot 2, a UE may receive CORESET A using TCI state 1 instead of TCI state 2 of CORESET A and may also receive CORESET B. Similarly, even in a case of a collision between CORESET A and CORESET A, a UE may find an intersection of type D RS in each CORESET and receive both CORESET A using the TCI state of the intersection. When there are two intersection type D RSs, only one type D RS may be selected according to a determined rule. For example, a QCL type D RS corresponding to a TCI state of the lowest CORESET ID among CORESETs having a collision may be selected.

Problem 3: A drop rule of a search space set during PDCCH overbooking will be described. In the NR system, in one slot in a primary cell (Pcell), a search space set that requires more BD/CCE operations than the number of PDCCH BDs and PDCCH CCEs that a UE can operate may be configured. This situation is referred to as PDCCH overbooking. In this case, a UE selects a search space set within the number of PDCCH BDs and PDCCH CCEs that it can calculate, and drops the remaining search space sets (i.e., a UE does not monitor a PDCCH of the corresponding search space). Here, a UE selects a search space set with a specific priority. Here, the specific priority means that a CSS has a higher priority than a USS, and the one with a smaller search space set identifier (ID) is given priority among USSs.

In addition, when the same PDCCH is repeatedly transmitted or the same PDCCH is divided and transmitted, if a corresponding search space set is overbooked in one slot with an existing search space set, by introducing a priority of Embodiments 3-1/ 3-2/3-3 to be described later, a UE can prioritize a specific search space set.

### Embodiment 3-1

When the same PDCCH was transmitted repeatedly/dividedly in the Embodiments 2-1/2-2, a priority was proposed when a corresponding CORESET and an existing CORESET collide. Similarly, when PDCCH overbooking occurs in order to solve the above-mentioned problem, a priority may be introduced/defined between a search space set in which the same PDCCH is repeatedly/dividedly transmitted and an existing search space set that is not. For example, a method in which a search space set in which the same PDCCH is repeatedly/dividedly transmitted has a higher priority over an existing search space set in which the same PDCCH is not transmitted or, conversely, a method in which an existing search space set has a higher priority may be considered. The technical basis for this is the same as the technical basis described in Embodiments 2-1/2-2 above.

The proposed priority may be applied prior to considering a search space set ID in an existing priority. Alternatively, the proposed priority may be applied prior to considering a priority between CSS/USS.

For example, a UE preferentially selects a search space set in which the same PDCCH is repeatedly/dividedly transmitted according to the above proposed method, and then preferentially selects a CSS from the remaining search space sets according to an existing method over a USS, and then preferentially selects the one with the smallest search space set ID among USSs.

### Embodiment 3-2

When the same PDCCH is divided into several search space sets (e.g., search space set 1 and search space set 2) and transmitted, if a UE drops some of the search space sets (due to a collision with an SSB/CRS, etc. as above), the UE may drop all the remaining search space sets as well. For example, some bits constituting one DCI may be transmitted as PDCCH candidate 1 in search space set 1, and some remaining bits may be transmitted as PDCCH candidate 2 in search space set 2. In this case, if search space set 1 is dropped, even if a UE receives PDCCH candidate 2 included in search space set 2, it is meaningless because DCI cannot be completely received. This is because information received through PDCCH candidate 2 corresponds to some bits of DCI, and some bits can be received only through dropped PDCCH candidate 1. For this reason, when the same PDCCH is divided into several search space sets (e.g., search space set 1 and search space set 2) and transmitted, if a UE drops some of the search space sets, it is preferable that the UE also drop all the remaining search space sets.

Alternatively, when the same PDCCH is dividedly/repeatedly transmitted into several search space sets (e.g., Search space set 1 and Search space set 2), if some of the search space sets (e.g., more than/less than N (N is a natural number) search space sets, where N=1 or a base station indicates a value of N to a UE) are dropped, a UE may deprioritize the remaining search space set. For example, it may be deprioritized to the lowest priority.

For example, it is assumed that the same PDCCH is dividedly/repeatedly transmitted into search space set 1 and set 2, and priorities of search space set 1 and search space set 2 are higher than that of other search space sets. In this case, if some search space sets (e.g., search space set 1) are dropped (according to an indication of a base station), a priority of the remaining search space sets (e.g., search space set 2) may be adjusted and changed to have a lower priority (e.g., lowest priority) than other search space sets.

When the same DCI is repeatedly transmitted or dividedly transmitted over several PDCCHs, each PDCCH may be self-decodable (i.e., a UE can receive DCI by decoding respective PDCCH) or non-self-decodable (i.e., a UE should decode along with other PDCCHs to receive DCI). For example, when transmitted dividedly, each PDCCH becomes non-self-decodable, and when transmitted repeatedly, each PDCCH is self-decodable.

When the same DCI is transmitted in non-self-decodable PDCCH candidates multiple times, if any one of them is dropped, a UE fails DCI decoding regardless of whether the remaining PDCCH candidates are received. Therefore, in this case, it is possible to reduce a possibility of dropping by prioritizing a corresponding search space set (a search space set in which PDCCH candidates are monitored). Alternatively, if even one PDCCH candidate is dropped, a UE may deprioritize a search space set of the remaining PDCCH candidates or drop it together.

For example, it is assumed that a specific search space set A includes only non-self-decodable PDCCH candidates and that search space set B includes only self-decodable PDCCH candidates. If search space set A and search space set B are configured simultaneously in an overbooking slot, a dropping rule may be applied in preference to search space set B over search space set A (i.e., a UE may drop search space set A first) . This is because PDCCH candidates transmitted in search space set B has a possibility of decoding without depending on PDCCH candidates of another search space set, however if reception of PDCCH candidates of another search space set configured for the same DCI transmission fails, even if a UE receives PDCCH candidates transmitted from search space set A well, decoding of PDCCH candidates transmitted from the search space set A fails. Alternatively, conversely, a dropping rule may be applied in preference to search space set A over search space set B (i.e., a UE may drop search space set B first). This is because, when search space set A is dropped, even if PDCCH candidates of another search space set configured for the same DCI transmission as search space set A is successfully received, a UE fails to decode DCI. In other words, a dropping rule (or priority rule) may be determined based on whether PDCCH candidates constituting the search space set are non-self decodable or self decodable.

### Embodiment 3-3

When the same PDCCH is repeatedly transmitted to several search space sets (e.g., search space set 1 and search space set 2), a UE may not drop at least one of repeatedly transmitted PDCCHs. This is because, in the worst case, if all PDCCHs repeatedly transmitted are dropped, it is impossible to achieve the original purpose of repeated transmission, which is to improve reliability. Therefore, it is preferable that a specific search space set (e.g., search space set with lowest ID) among repeatedly transmitted search space sets has a higher priority than other search space sets to ensure that at least one of repeatedly transmitted PDCCHs can be transmitted and received.

Alternatively, if N or more search space sets (e.g., N=1 or a base station indicates the N value to a UE) among search space sets that are repeatedly transmitted are dropped by an existing dropping rule, the priority of the remaining search space sets may be increased to ensure that the remaining search space sets are not dropped. Alternatively, conversely, in the above case, the priority of the remaining set may be lowered (e.g., lowered to the lowest priority).

The proposed priority may be applied first before considering a search space set ID in an existing priority. Alternatively, a priority between CSS/USS may be applied prior to consideration.

For example, after a UE changes and applies the priority of one or more specific search space sets according to the above proposed method, according to an existing method, a CSS may be selected prior to a USS among the remaining search space sets, and a search space set ID having a smaller search space set ID may be selected preferentially among USSs.

With respect to the above-described proposals (e.g., Embodiments 1-1/1-2/1-3/1-4/1-5, Embodiments 2-1/2-2/2-3, Embodiments 3-1/3-2/3-3, etc.) of the present disclosure, a base station may indicate/configure to a UE by selecting which proposal the UE will operate according to. Alternatively, since implementation complexity of a UE may vary according to each proposed operation, a UE may report to a base station which one or more proposed methods can be supported with capability information, and a base station may indicate/configure for a UE to perform any one of the one or more proposed schemes.

In the present disclosure, when a PDCCH is transmitted a plurality of times, the proposed method has been described as an example in which the same PDCCH (i.e., the same DCI) is repeatedly transmitted, but this is only an example for convenience of description. That is, even when the same PDCCH (i.e., the same DCI) is divided and transmitted over a plurality of times, the above-described proposed method can be extended and applied. In addition, in the present disclosure, when the PDCCH is transmitted a plurality of times, the proposed method has been described as an example in which the same PDCCH (i.e., the same DCI) is divided and transmitted, but this is only an example for convenience of description, that is, even when the same PDCCH (i.e., the same DCI) is repeatedly transmitted over a plurality of times, the proposed method can be extended and applied.

In addition, the proposals described (e.g., Embodiments 1-1/1-2/1-3/1-4/1-5, Embodiments 2-1/2-2/2-3, Embodiments 3-1/3-2/3-3, etc.) in the present disclosure may be operated independently, or any one or more embodiments may be applied in combination with each other.

FIGS. 8 and 9 illustrates a signaling procedure between a network and a terminal for a method of transmitting and receiving a PDCCH according to an embodiment of the present disclosure.

The after-described FIGS. 8 and 9 illustrate signaling between a network (e.g., TRP 1, TRP 2) and a terminal (i.e., UE) in a situation of multiple TRPs (i.e., M-TRPs, or multiple cells, hereinafter, all TRPs may be replaced with a cell) that methods proposed in the present disclosure (e.g., Embodiments 1-1/1-2/1-3/1-4/1-5, Embodiments 2-1/2-2/2-3, Embodiments 3-1/3-2/3-3, etc.) may be applied.

Here, a UE/a network is just an example, and may be applied by being substituted with a variety of devices as described in the after-described FIG. 12. FIGS. 8 and 9 are just for convenience of a description, and do not limit a scope of the present disclosure. In addition, some step(s) shown in FIGS. 8 and 9 may be omitted according to a situation and/or a configuration, etc.

In reference to FIGS. 8 and 9, for convenience of a description, signaling between 2 TRPs and UE is considered, but a corresponding signaling method may be extended and applied to signaling between multiple TRPs and multiple UEs. In the following description, a network may be one base station including a plurality of TRPs or may be one cell including a plurality of TRPs. In an example, an ideal/a non-ideal backhaul may be configured between TRP 1 and TRP 2 configuring a network. In addition, the following description is described based on multiple TRPs, but it may be equally extended and applied to transmission through multiple panels. In addition, in the present disclosure, an operation that a terminal receives a signal from TRP1/TRP2 may be interpreted/described (or may be an operation) as an operation that a terminal receives a signal from a network (through/with TRP1/2) and an operation that a terminal transmits a signal to TRP1/TRP2 may be interpreted/described (or may be an operation) as an operation that a terminal transmits a signal to a network (through/with TRP1/TRP2) or may be inversely interpreted/described.

In addition, as described above, a “TRP” may be applied by being substituted with an expression such as a panel, an antenna array, a cell (e.g., a macro cell/a small cell/a pico cell, etc.), a TP (transmission point), a base station (gNB, etc.), etc. As described above, a TRP may be classified according to information on a CORESET group (or a CORESET pool) (e.g., an index, an identifier (ID)). In an example, when one terminal is configured to perform transmission and reception with multiple TRPs (or cells), it may mean that multiple CORESET groups (or CORESET pools) are configured for one terminal. Such a configuration on a CORESET group (or a CORESET pool) may be performed through higher layer signaling (e.g., RRC signaling, etc.). In addition, a base station may generally mean an object which performs transmission and reception of data with a terminal. For example, a base station may be a concept including one or more TPs (Transmission Points), one or more TRPs (Transmission and Reception Points), etc. In addition, a TP and/or a TRP may include a panel of a base station, a transmission and reception unit, etc.

Specifically, FIG. 8 represents signaling for a case in which a terminal receives multiple DCI (e.g., when each TRP transmits DCI to a UE) in a situation of M-TRPs (or, a cell, hereinafter, all TRPs may be substituted with a cell, or even when a plurality of CORESETs are configured from one TRP, it may be assumed as M-TRPs).

In reference to FIG. 8, a UE may receive configuration information on Multiple TRP-based transmission and reception through/with TRP 1 (and/or TRP 2) from a Network (S801).

The configuration information may include information related to a configuration of a network (i.e., a TRP configuration), resource (resource allocation) information related to Multiple TRP-based transmission and reception, etc. Here, the configuration information may be transmitted through higher layer signaling (e.g., RRC signaling, MAC-CE, etc.). In addition, when the configuration information is predefined or preconfigured, a corresponding step may be omitted. For example, the configuration information may include a CORESET-related configuration / CCE configuration information / search space-related information / information related to repetitive transmission of a control channel (e.g., a PDCCH) (e.g., whether repetitive transmission is performed / the number of times of repetitive transmission, etc.) / a collision of resources related to a control channel (e.g., PDCCH) / information related to overbooking (e.g., the number of PDCCH candidates to be dropped in case of collision / priority related information, etc.) as described in the above-described proposal (e.g., Embodiments 1-1/1-2/1-3/1-4/1-5, Embodiments 2-1/2-2/2-3, Embodiments 3-1/3-2/3-3, etc.).

For example, the configuration information may include CORESET-related configuration information (e.g., ControlResourceSet IE) as described in the above-described methods (e.g., Embodiments 1-1/1-2/1-3/1-4/1-5, Embodiments 2-1/2-2/2-3, Embodiments 3-1/3-2/3-3, etc.). The CORESET-related configuraion information may include a CORESET-related ID (e.g., controlResourceSetID), an index of a CORESET pool for a CORESET (e.g., CORESETPoolIndex), a time/frequency resource configuration of a CORESET, TCI information related to a CORESET, etc. For example, the configuration information may include repeated transmission scheme (e.g., Repetitionscheme) information. In addition, a quasi co-location (QCL) reference signal (RS) for one or more CORESETs may be configured by the TCI information. Specifically, the TCI information may include QCL type information and/or information on a reference RS (reference signal) having a QCL relationship with a PDCCH DMRS port in the CORESET (or a serving cell in which the CORESET is configured).

A UE may receive DCI 1 and data 1 scheduled by corresponding DCI 1 through/using TRP 1 from a Network (S802). In addition, UE may receive DCI 2 and data 2 scheduled by corresponding DCI 2 through/using TRP 2 from a Network (S803).

DCI (e.g., DCI 1, DCI 2) and Data (e.g., Data 1, Data 2) may be transmitted through a control channel (e.g., a PDCCH, etc.) and a data channel (e.g., a PDSCH, etc.), respectively. For example, the control channel (e.g., a PDCCH) may be repetitively transmitted or the same control channel may be partitively transmitted. In addition, Step S802 and Step S803 may be performed simultaneously or any one may be performed earlier than the other.

For example, the DCI 1 and the DCI 2 are (indication) information for a TCI state described in the above-described methods (e.g., Embodiments 1-1/1-2/1-3/1-4/1-5, Embodiments 2-1/2-2/2-3, Embodiments 3-1/3-2/3-3, etc.), resource allocation information (i.e., spatial/frequency/time resources) for DMRS and/or data, etc.

For example, TRP1 and/or TRP2 may repetitively/partitively transmit the same DCI. In one example, a PDCCH candidate for each TRP that the DCI 1 and the DCI 2 is transmitted may correspond to a different TCI state (or different QCL type-D reference RS). In other words, a control channel (e.g., a PDCCH) that the DCI 1 and the DCI 2 are transmitted may be repetitively transmitted based on a TDM/FDM/SDM method or the same control channel may be partitively transmitted. For example, a resource through which the control channel (e.g., PDCCH) is transmitted may collide with another signal/resource (e.g., SSB/CRS/CORESET that is not repeated or divided transmission, etc.), as described in the above-described proposed methods (e.g., Embodiments 1-1/1-2/1-3/1-4/1-5, Embodiments 2-1/2-2/2-3, Embodiments 3-1/3-2/3-3, etc.), operations such as drop/rate matching/puncturing for any one CORESET may be performed based on a priority rule. For example, an operation such as drop/rate matching/puncturing may be performed based on a priority between a search space set associated with a control channel (e.g., PDCCH) transmitted repeatedly or dividedly and another SS set. For example, based on whether PDCCH candidates constituting a search space set are non-self decodable/self decodable, a dropping rule (or a priority rule) may be determined. For example, if some search space sets among a plurality of search space sets associated with a control channel (e.g., PDCCH) transmitted repeatedly/dividedly are dropped, the priority of the remaining search space sets may be changed and a dropping rule/priority rule may be applied.

For example, PDCCH candidates may be composed of CCEs in which other signals/resources (e.g., SSB/CRS, etc.) do not collide. PDCCH candidates may be configured by remapping CCE indexes except for a CCE that collides based on a specific hashing function.

For example, a UE may receive a plurality of CORESETs in which TCI states are configured differently (i.e., reference RSs of QCL type D are configured differently) at one moment (/same timing/the same occasion) using a plurality of panels. Receiving a CORESET may mean receiving a PDCCH (including DCI) through/in a CORESET. In other words, it may mean monitoring (i.e., decoding) PDCCH candidates in a corresponding CORESET based on a reference RS of QCL type D configured for the corresponding CORESET. Here, when the total number of configured TCI states is greater than the number of panels that a UE can receive, it may operate based on the above-described proposed methods (e.g., Embodiments 1-1/1-2/1-3/1-4/1-5, Embodiments 2-1/2-2/2-3, Embodiments 3-1/3-2/3-3, etc.). For example, a CORESET may be selected by applying an existing priority rule for each CORESET pool. In addition, when there is a collision between the selected CORESETs (i.e., if the number of TCI states configured in the selected CORESETs is greater than the number of receivable panels of a UE), an operation may be performed based on a priority rule described in the above-described embodiments 2-1/2-2/ 2-3.

A UE may decode Data 1 and Data 2 received through/using TRP 1 (and/or TRP 2) from a Network (S804). For example, a UE may perform channel estimation and/or decoding on data based on the above-described methods (e.g., Embodiments 1-1/1-2/1-3/1-4/1-5, Embodiments 2-1/2-2/2-3, Embodiments 3-1/3-2/3-3, etc.). For example, according to a definition of a candidate of a control channel (e.g., PDCCH) (e.g., defined based on a CORESET/SS set), channel estimation and/or data decoding may be performed by applying an aggregation level/TCI state mapping, etc.

A UE may transmit HARQ-ACK information (e.g., ACK information, NACK information, etc.) for Data 1 and/or Data 2 to a Network through/using TRP 1 and/or TRP 2 (S805, S806). In this case, HARQ-ACK information for Data 1 and Data 2 may be aggregated into one. In addition, a UE is configured to transmit only HARQ-ACK information to a representative TRP (e.g., TRP 1), and transmission of HARQ-ACK information to the other TRP (e.g., TRP 2) may be omitted.

FIG. 9 represents signaling for a case in which a terminal receives single DCI (e.g., when a single TRP transmits DCI to a UE) in a situation of M-TRPs (or, a cell, hereinafter, all TRPs may be substituted with a cell, or even when a plurality of CORESETs are configured from one TRP, it may be assumed as M-TRPs). In FIG. 9, it is assumed that TRP 1 is a representative TRP for transmitting DCI.

In reference to FIG. 9, a UE may receive configuration information on Multiple TRP-based transmission and reception through/with TRP 1 (and/or TRP 2) from a Network side (S901).

The configuration information may include information related to a configuration of a network (i.e., a TRP configuration), resource (resource allocation) information related to Multiple TRP-based transmission and reception, etc. Here, the configuration information may be transmitted through higher layer signaling (e.g., RRC signaling, MAC-CE, etc.). In addition, when the configuration information is predefined or preconfigured, a corresponding step may be omitted. For example, the configuration information may include a CORESET-related configuration / CCE configuration information / search space-related information / information related to repetitive transmission of a control channel (e.g., a PDCCH) (e.g., whether repetitive transmission is performed / the number of times of repetitive transmission, etc.) / a collision of resources related to a control channel (e.g., PDCCH) / information related to overbooking (e.g., the number of PDCCH candidates to be dropped in case of collision / priority related information, etc.) as described in the above-described proposal (e.g., Embodiments 1-1/1-2/1-3/1-4/1-5, Embodiments 2-1/2-2/2-3, Embodiments 3-1/3-2/3-3, etc.).

For example, the configuration information may include CORESET-related configuration information (e.g., ControlResourceSet IE) as described in the above-described methods (e.g., Embodiments 1-1/1-2/1-3/1-4/1-5, Embodiments 2-1/2-2/2-3, Embodiments 3-1/3-2/3-3, etc.). The CORESET-related configuraion information may include a CORESET-related ID (e.g., controlResourceSetID), an index of a CORESET pool for a CORESET (e.g., CORESETPoolIndex), a time/frequency resource configuration of a CORESET, TCI information related to a CORESET, etc. For example, the configuration information may include repeated transmission scheme (e.g., Repetitionscheme) information. In addition, a quasi co-location (QCL) reference signal (RS) for one or more CORESETs may be configured by the TCI information. Specifically, the TCI information may include QCL type information and/or information on a reference RS (reference signal) having a QCL relationship with a PDCCH DMRS port in the CORESET (or a serving cell in which the CORESET is configured).

A UE may receive DCI and data 1 scheduled by corresponding DCI through/using TRP 1 from a Network (S902). In addition, UE may receive data 2 scheduled by corresponding DCI 2 through/using TRP 2 from a Network (S903). Here, DCI may be configured to be used for scheduling for both Data 1 and Data 2. DCI and Data (e.g., Data 1, Data 2) may be transmitted through a control channel (e.g., a PDCCH, etc.) and a data channel (e.g., a PDSCH, etc.), respectively. In addition, Step S902 and Step S903 may be performed simultaneously or any one may be performed earlier than the other.

For example, the DCI 1 is (indication) information for a TCI state described in the above-described methods (e.g., Embodiments 1-1/1-2/1-3/1-4/1-5, Embodiments 2-1/2-2/2-3, Embodiments 3-1/3-2/3-3, etc.), resource allocation information (i.e., spatial/frequency/time resources) for DMRS and/or data, etc.

For example, TRP1 and/or TRP2 may repetitively/partitively transmit the same DCI. In one example, a PDCCH candidate for each TRP that the DCI 1 and the DCI 2 is transmitted may correspond to a different TCI state (or different QCL type-D reference RS). In other words, a control channel (e.g., a PDCCH) that the DCI is transmitted may be repetitively transmitted based on a TDM/FDM/SDM method or the same control channel may be partitively transmitted. For example, a resource through which the control channel (e.g., PDCCH) is transmitted may collide with another signal/resource (e.g., SSB/CRS/CORESET that is not repeated or divided transmission, etc.), as described in the above-described proposed methods (e.g., Embodiments 1-1/1-2/1-3/1-4/1-5, Embodiments 2-1/2-2/2-3, Embodiments 3-1/3-2/3-3, etc.), operations such as drop/rate matching/puncturing for any one CORESET may be performed based on a priority rule. For example, an operation such as drop/rate matching/puncturing may be performed based on a priority between a search space set associated with a control channel (e.g., PDCCH) transmitted repeatedly or dividedly and another SS set. For example, based on whether PDCCH candidates constituting a search space set are non-self decodable/self decodable, a dropping rule (or a priority rule) may be determined. For example, if some search space sets among a plurality of search space sets associated with a control channel (e.g., PDCCH) transmitted repeatedly/dividedly are dropped, the priority of the remaining search space sets may be changed and a dropping rule/priority rule may be applied.

For example, PDCCH candidates may be composed of CCEs in which other signals/resources (e.g., SSB/CRS, etc.) do not collide. PDCCH candidates may be configured by remapping CCE indexes except for a CCE that collides based on a specific hashing function.

For example, a UE may receive a plurality of CORESETs in which TCI states are configured differently (i.e., reference RSs of QCL type D are configured differently) at one moment (/same timing/the same occasion) using a plurality of panels. Receiving a CORESET may mean receiving a PDCCH (including DCI) through/in a CORESET. In other words, it may mean monitoring (i.e., decoding) PDCCH candidates in a corresponding CORESET based on a reference RS of QCL type D configured for the corresponding CORESET. Here, when the total number of configured TCI states is greater than the number of panels that a UE can receive, it may operate based on the above-described proposed methods (e.g., Embodiments 1-1/1-2/1-3/1-4/1-5, Embodiments 2-1/2-2/2-3, Embodiments 3-1/3-2/3-3, etc.). For example, a CORESET may be selected by applying an existing priority rule for each CORESET pool. In addition, when there is a collision between the selected CORESETs (i.e., if the number of TCI states configured in the selected CORESETs is greater than the number of receivable panels of a UE) , an operation may be performed based on a priority rule described in the above-described embodiments 2-1/2-2/ 2-3.

A UE may decode Data 1 and Data 2 received through/using TRP 1 (and/or TRP 2) from a Network (S904). For example, a UE may perform channel estimation and/or decoding on data based on the above-described methods (e.g., Embodiments 1-1/1-2/1-3/1-4/1-5, Embodiments 2-1/2-2/2-3, Embodiments 3-1/3-2/3-3, etc.). For example, according to a definition of a candidate of a control channel (e.g., PDCCH) (e.g., defined based on a CORESET/SS set), channel estimation and/or data decoding may be performed by applying an aggregation level/TCI state mapping, etc.

A UE may transmit HARQ-ACK information (e.g., ACK information, NACK information, etc.) for Data 1 and/or Data 2 to a Network through/using TRP 1 and/or TRP 2 (S905, S906). In this case, HARQ-ACK information for Data 1 and Data 2 may be aggregated into one. In addition, a UE is configured to transmit only HARQ-ACK information to a representative TRP (e.g., TRP 1), and transmission of HARQ-ACK information to the other TRP (e.g., TRP 2) may be omitted.

As mentioned above, the above-described Network/UE signaling and operation (e.g., Embodiments 1-1/1-2/1-3/1-4/1-5, Embodiments 2-1/2-2/2-3, Embodiments 3-1/3-2/3-3/ FIG. 8 and FIG. 9, etc.) may be implemented by an apparatus (e.g., FIG. 12) to be described below. For example, a network (e.g., TRP 1/TRP 2) may correspond to a first wireless device, a UE may correspond to a second wireless device, and vice versa may be considered in some cases.

For example, the above-described Network/UE signaling and operation (e.g., Embodiments 1-1/1-2/1-3/1-4/1-5, Embodiments 2-1/2-2/2-3, Embodiments 3-1/3–2/3-3/ FIG. 8 and FIG. 9, etc.) may be processed by one or more processors (e.g., 102, 202) of FIG. 12, and the above-described Network/UE signaling and operation (e.g., Embodiments 1-1/1-2/1-3/1-4/1-5, Embodiments 2-1/2-2/2-3, Embodiments 3-1/3-2/3-3/ FIG. 8 and FIG. 9, etc.) may be stored in a memory (e.g., one or more memories (e.g., 104, 204) of FIG. 12) in a form of an instruction/program (e.g., instruction, executable code) for driving at least one processor (e.g., 102, 202) of FIG. 12.

FIG. 10 is a diagram which illustrates an operation of a terminal for receiving a PDCCH according to an embodiment of the present disclosure.

FIG. 10 illustrate an operation of a terminal based on Embodiments 1-1/1-2/1-3/1-4/1-5, Embodiments 2-1/2-2/2-3, Embodiments 3-1/3-2/3-3. An example of FIG. 10 is for convenience of description, and does not limit the scope of the present disclosure. Some step(s) illustrated in FIG. 10 may be omitted depending on circumstances and/or configurations. In addition, the terminal in FIG. 10 is only one example, and may be implemented as the device illustrated in FIG. 12 below. For example, the processor (102/202) of FIG. 12 may control to transmit/receive a channel/signal/data/information using the transceiver (106/206), and may control transmitted or received a channel/signal/ data/information to be stored in the memory (104/204) .

In addition, an operation of FIG. 10 may be processed by one or more processors (e.g., 102, 202) of FIG. 12, and an operation of FIG. 10 may be stored in a memory (e.g., one or more memories (e.g., 104, 204) of FIG. 12) in a form of an instruction/program (e.g., instruction, executable code) for driving at least one processor (e.g., 102, 202) of FIG. 12.

A terminal receives configuration information related to one or more CORESETs from a base station (S1001).

The configuration information may include CORESET-related configuration information (e.g., ControlResourceSet IE) as described in the above-described methods (e.g., Embodiments 1-1/1-2/1-3/1-4/1-5, Embodiments 2-1/2-2/2-3, Embodiments 3-1/3-2/3-3, etc.). The CORESET-related configuraion information may include a CORESET-related ID (e.g., controlResourceSetID), an index of a CORESET pool for a CORESET (e.g., CORESETPoolIndex) a time/frequency resource configuration of a CORESET, TCI information related to a CORESET, etc. For example, the configuration information may include repeated transmission scheme (e.g., Repetitionscheme) information. In addition, a quasi co-location (QCL) reference signal (RS) for one or more CORESETs may be configured by the TCI information. Specifically, the TCI information may include QCL type information and/or information on a reference RS (reference signal) having a QCL relationship with a PDCCH DMRS port in the CORESET (or a serving cell in which the CORESET is configured).

A terminal receives a PDCCH in one or more CORESETs from a base station (S1002).

As described above, different TPPs (e.g., base stations) may transmit the same DCI repeatedly/dividedly. As an example, PDCCH candidates for each TRP may correspond to different TCI states (or different QCL type D reference RSs). In other words, a control channel (e.g., a PDCCH) that DCI 1 is transmitted may be repetitively transmitted based on a TDM/FDM/SDM method or the same control channel may be partitively transmitted. For example, a resource through which the control channel (e.g., PDCCH) is transmitted may collide with another signal/resource (e.g., SSB/CRS/CORESET that is not repeated or divided transmission, etc.), as described in the above-described proposed methods (e.g., Embodiments 1-1/1-2/1-3/1-4/1-5, Embodiments 2-1/2-2/2-3, Embodiments 3-1/3-2/3-3, etc.), operations such as drop/rate matching/puncturing for any one CORESET may be performed based on a priority rule. For example, an operation such as drop/rate matching/puncturing may be performed based on a priority between a search space set associated with a control channel (e.g., PDCCH) transmitted repeatedly or dividedly and another SS set. For example, based on whether PDCCH candidates constituting a search space set are non-self decodable/self decodable, a dropping rule (or a priority rule) may be determined. For example, if some search space sets among a plurality of search space sets associated with a control channel (e.g., PDCCH) transmitted repeatedly/dividedly are dropped, the priority of the remaining search space sets may be changed and a dropping rule/priority rule may be applied.

For example, PDCCH candidates may be composed of CCEs in which other signals/resources (e.g., SSB/CRS, etc.) do not collide. PDCCH candidates may be configured by remapping CCE indexes except for a CCE that collides based on a specific hashing function.

For example, a UE may receive a plurality of CORESETs in which TCI states are configured differently (i.e., reference RSs of QCL type D are configured differently) at one moment (/same timing/the same occasion) using a plurality of panels. Receiving a CORESET may mean receiving a PDCCH (including DCI) through/in a CORESET. In other words, it may mean monitoring (i.e., decoding) PDCCH candidates in a corresponding CORESET based on a reference RS of QCL type D configured for the corresponding CORESET. Here, when the total number of configured TCI states is greater than the number of panels that a UE can receive, it may operate based on the above-described proposed methods (e.g., Embodiments 1-1/1-2/1-3/1-4/1-5, Embodiments 2-1/2-2/2-3, Embodiments 3-1/3-2/3-3, etc.). For example, a CORESET may be selected by applying an existing priority rule for each CORESET pool. In addition, when there is a collision between the selected CORESETs (i.e., if the number of TCI states configured in the selected CORESETs is greater than the number of receivable panels of a UE) , an operation may be performed based on a priority rule described in the above-described embodiments 2-1/2-2/ 2-3.

More specifically, based on a first CORESET in which a plurality of QCL reference RSs are configured and a second CORESET in which one or more QCL reference RSs being configured to monitor PDCCH candidates in the same time unit (i.e. based on different CORESETs colliding in the same time unit), the PDCCH candidates may be monitored by the UE in the first CORESET and/or the second CORESET based on a specific number of different QCL reference RSs.

Here, the first CORESET and the second CORESET may be configured with different CORESET pool indexes. In this case, PDCCH candidates may be monitored based on one QCL reference RS among the plurality of QCL reference RSs in the first CORESET, and PDCCH candidates may be monitored based on one QCL reference RS among the one or more QCL reference RSs in the second CORESET. Alternatively, the PDCCH candidates may be monitored based on a plurality of QCL reference RSs only in the first CORESET. Alternatively, based on one QCL reference RS being configured in the second CORESET, the PDCCH candidates may be monitored based on one QCL reference RS related to the second CORESET only in the second CORESET. In this case, the PDCCH candidates may be monitored even in a CORESET in which the same CORESET pool index and the same QCL reference RS as the second CORESET are configured. Alternatively, based on a plurality of QCL reference RSs being configured in the second CORESET, the PDCCH candidates may be monitored based on the plurality of QCL reference RSs related to the second CORESET only in the second CORESET.

Alternatively, a first CORESET and a second CORESET may be configured with the same CORESET pool index. Here, the PDCCH candidates may be monitored based on one QCL reference RS among the plurality of QCL reference RSs in the first CORESET, and the PDCCH candidates may be monitored based on one QCL reference RS among the one or more QCL reference RSs in the second CORESET. Alternatively, the PDCCH candidates may be monitored based on the plurality of QCL reference RSs only in the first CORESET. Alternatively, based on one QCL reference RS being configured in the second CORESET, the PDCCH candidates may be monitored based on one QCL reference RS related to the second CORESET only in the second CORESET. In this case, the PDCCH candidates may be monitored even in a CORESET in which the same CORESET pool index and the same QCL reference RS as the second CORESET are configured. Alternatively, based on a plurality of QCL reference RSs being configured in the second CORESET, the PDCCH candidates may be monitored based on a plurality of QCL reference RSs related to the second CORESET only in the second CORESET.

Thereafter, a terminal may perform data transmission/reception with a base station based on the received PDCCH (i.e., DCI).

FIG. 11 is a diagram which illustrates an operation of a base station for transmitting a PDCCH according to an embodiment of the present disclosure.

FIG. 11 illustrate an operation of a base station based on Embodiments 1-1/1-2/1-3/1-4/1-5, Embodiments 2-1/2-2/2-3, Embodiments 3-1/3-2/3-3. An example of FIG. 11 is for convenience of description, and does not limit the scope of the present disclosure. Some step(s) illustrated in FIG. 11 may be omitted depending on circumstances and/or configurations. In addition, the base station in FIG. 11 is only one example, and may be implemented as the device illustrated in FIG. 12 below. For example, the processor (102/202) of FIG. 12 may control to transmit/receive a channel/signal/data/information using the transceiver (106/206), and may control transmitted or received a channel/signal/ data/information to be stored in the memory (104/204) .

In addition, an operation of FIG. 11 may be processed by one or more processors (e.g., 102, 202) of FIG. 12, and an operation of FIG. 11 may be stored in a memory (e.g., one or more memories (e.g., 104, 204) of FIG. 12) in a form of an instruction/program (e.g., instruction, executable code) for driving at least one processor (e.g., 102, 202) of FIG. 12.

A base station transmits configuration information related to one or more CORESETs to a terminal (S1101).

The configuration information may include CORESET-related configuration information (e.g., ControlResourceSet IE) as described in the above-described methods (e.g., Embodiments 1-1/1-2/1-3/1-4/1-5, Embodiments 2-1/2-2/2-3, Embodiments 3-1/3-2/3-3, etc.). The CORESET-related configuraion information may include a CORESET-related ID (e.g., controlResourceSetID), an index of a CORESET pool for a CORESET (e.g., CORESETPoolIndex), a time/frequency resource configuration of a CORESET, TCI information related to a CORESET, etc. For example, the configuration information may include repeated transmission scheme (e.g., Repetitionscheme) information. In addition, a quasi co-location (QCL) reference signal (RS) for one or more CORESETs may be configured by the TCI information. Specifically, the TCI information may include QCL type information and/or information on a reference RS (reference signal) having a QCL relationship with a PDCCH DMRS port in the CORESET (or a serving cell in which the CORESET is configured).

A base station transmits a PDCCH in one or more CORESETs to a terminal (S1102).

As described above, different TPPs (e.g., base stations) may transmit the same DCI repeatedly/dividedly. As an example, PDCCH candidates for each TRP may correspond to different TCI states (or different QCL type D reference RSs). In other words, a control channel (e.g., a PDCCH) that DCI 1 is transmitted may be repetitively transmitted based on a TDM/FDM/SDM method or the same control channel may be partitively transmitted. For example, a resource through which the control channel (e.g., PDCCH) is transmitted may collide with another signal/resource (e.g., SSB/CRS/CORESET that is not repeated or divided transmission, etc.), as described in the above-described proposed methods (e.g., Embodiments 1-1/1-2/1-3/1-4/1-5, Embodiments 2-1/2-2/2-3, Embodiments 3-1/3-2/3-3, etc.), operations such as drop/rate matching/puncturing for any one CORESET may be performed based on a priority rule. For example, an operation such as drop/rate matching/puncturing may be performed based on a priority between a search space set associated with a control channel (e.g., PDCCH) transmitted repeatedly or dividedly and another SS set. For example, based on whether PDCCH candidates constituting a search space set are non-self decodable/self decodable, a dropping rule (or a priority rule) may be determined. For example, if some search space sets among a plurality of search space sets associated with a control channel (e.g., PDCCH) transmitted repeatedly/dividedly are dropped, the priority of the remaining search space sets may be changed and a dropping rule/priority rule may be applied.

For example, PDCCH candidates may be composed of CCEs in which other signals/resources (e.g., SSB/CRS, etc.) do not collide. PDCCH candidates may be configured by remapping CCE indexes except for a CCE that collides based on a specific hashing function.

For example, a UE may receive a plurality of CORESETs in which TCI states are configured differently (i.e., reference RSs of QCL type D are configured differently) at one moment (/same timing/the same occasion) using a plurality of panels. Receiving a CORESET may mean receiving a PDCCH (including DCI) through/in a CORESET. In other words, it may mean monitoring (i.e., decoding) PDCCH candidates in a corresponding CORESET based on a reference RS of QCL type D configured for the corresponding CORESET. Here, when the total number of configured TCI states is greater than the number of panels that a UE can receive, it may operate based on the above-described proposed methods (e.g., Embodiments 1-1/1-2/1-3/1-4/1-5, Embodiments 2-1/2-2/2-3, Embodiments 3-1/3-2/3-3, etc.). For example, a CORESET may be selected by applying an existing priority rule for each CORESET pool. In addition, when there is a collision between the selected CORESETs (i.e., if the number of TCI states configured in the selected CORESETs is greater than the number of receivable panels of a UE) , an operation may be performed based on a priority rule described in the above-described embodiments 2-1/2-2/ 2-3.

More specifically, based on a first CORESET in which a plurality of QCL reference RSs are configured and a second CORESET in which one or more QCL reference RSs being configured to monitor PDCCH candidates in the same time unit (i.e. based on different CORESETs colliding in the same time unit), the PDCCH candidates may be monitored by the UE in the first CORESET and/or the second CORESET based on a specific number of different QCL reference RSs.

Here, the first CORESET and the second CORESET may be configured with different CORESET pool indexes. In this case, PDCCH candidates may be monitored based on one QCL reference RS among the plurality of QCL reference RSs in the first CORESET, and PDCCH candidates may be monitored based on one QCL reference RS among the one or more QCL reference RSs in the second CORESET. Here, based on a QCL reference RS configured by a predetermined TCI state among a plurality of TCI states for the first CORESET, PDCCH candidates may be monitored in the first CORESET. For example, based on a QCL reference RS configured by the first TCI state or the second TCI state or the last TCI state or the TCI state having the lowest TCI state identity or the TCI state having the highest TCI state identity, PDCCH candidates may be monitored in the first CORESET. Alternatively, the PDCCH candidates may be monitored based on a plurality of QCL reference RSs only in the first CORESET. Alternatively, based on one QCL reference RS being configured in the second CORESET, the PDCCH candidates may be monitored based on one QCL reference RS related to the second CORESET only in the second CORESET. In this case, the PDCCH candidates may be monitored even in a CORESET in which the same CORESET pool index and the same QCL reference RS as the second CORESET are configured. Alternatively, based on a plurality of QCL reference RSs being configured in the second CORESET, the PDCCH candidates may be monitored based on the plurality of QCL reference RSs related to the second CORESET only in the second CORESET.

Alternatively, a first CORESET and a second CORESET may be configured with the same CORESET pool index. Here, the PDCCH candidates may be monitored based on one QCL reference RS among the plurality of QCL reference RSs in the first CORESET, and the PDCCH candidates may be monitored based on one QCL reference RS among the one or more QCL reference RSs in the second CORESET. Here, based on a QCL reference RS configured by a predetermined TCI state among a plurality of TCI states for the first CORESET, PDCCH candidates may be monitored in the first CORESET. For example, based on a QCL reference RS configured by the first TCI state or the second TCI state or the last TCI state or the TCI state having the lowest TCI state identity or the TCI state having the highest TCI state identity, PDCCH candidates may be monitored in the first CORESET. Alternatively, the PDCCH candidates may be monitored based on the plurality of QCL reference RSs only in the first CORESET. Alternatively, based on one QCL reference RS being configured in the second CORESET, the PDCCH candidates may be monitored based on one QCL reference RS related to the second CORESET only in the second CORESET. In this case, the PDCCH candidates may be monitored even in a CORESET in which the same CORESET pool index and the same QCL reference RS as the second CORESET are configured. Alternatively, based on a plurality of QCL reference RSs being configured in the second CORESET, the PDCCH candidates may be monitored based on a plurality of QCL reference RSs related to the second CORESET only in the second CORESET.

Thereafter, a base station may perform data transmission/reception with a terminal based on the transmitted PDCCH (i.e., DCI).

### General Device to Which the Present Disclosure May be Applied

FIG. 12 is a diagram which illustrates a block diagram of a wireless communication device according to an embodiment of the present disclosure.

In reference to FIG. 12, a first wireless device 100 and a second wireless device 200 may transmit and receive a wireless signal through a variety of radio access technologies (e.g., LTE, NR).

A first wireless device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts disclosed in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including commands for performing all or part of processes controlled by a processor 102 or for performing description, functions, procedures, proposals, methods and/or operation flow charts disclosed in the present disclosure. Here, a processor 102 and a memory 104 may be part of a communication modem/circuit/chip designed to implement a wireless communication technology (e.g., LTE, NR). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a wireless device may mean a communication modem/circuit/chip.

A second wireless device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts disclosed in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including commands for performing all or part of processes controlled by a processor 202 or for performing description, functions, procedures, proposals, methods and/or operation flow charts disclosed in the present disclosure. Here, a processor 202 and a memory 204 may be part of a communication modem/circuit/chip designed to implement a wireless communication technology (e.g., LTE, NR). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a wireless device may mean a communication modem/circuit/chip.

Hereinafter, a hardware element of a wireless device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC, RLC, PDCP, RRC, SDAP). One or more processors 102, 202 may generate one or more PDUs (Protocol Data Unit) and/or one or more SDUs (Service Data Unit) according to description, functions, procedures, proposals, methods and/or operation flow charts included in the present disclosure. One or more processors 102, 202 may generate a message, control information, data or information according to description, functions, procedures, proposals, methods and/or operation flow charts disclosed in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts disclosed in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs(Application Specific Integrated Circuit), one or more DSPs(Digital Signal Processor), one or more DSPDs(Digital Signal Processing Device), one or more PLDs(Programmable Logic Device) or one or more FPGAs(Field Programmable Gate Arrays) may be included in one or more processors 102, 202. Description, functions, procedures, proposals, methods and/or operation flow charts disclosed in the present disclosure may be implemented by using a firmware or a software and a firmware or a software may be implemented to include a module, a procedure, a function, etc. A firmware or a software configured to perform description, functions, procedures, proposals, methods and/or operation flow charts disclosed in the present disclosure may be included in one or more processors 102, 202 or may be stored in one or more memories 104, 204 and driven by one or more processors 102, 202. Description, functions, procedures, proposals, methods and/or operation flow charts disclosed in the present disclosure may be implemented by using a firmware or a software in a form of a code, a command and/or a set of commands.

One or more memories 104, 204 may be connected to one or more processors 102, 202 and may store data, a signal, a message, information, a program, a code, an instruction and/or a command in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. disclosed in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. disclosed in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefor, one or more transceivers 106, 206 may include an (analogue) oscillator and/or a filter.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure.

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

Here, a wireless communication technology implemented in a wireless device 100, 200 of the present disclosure may include Narrowband Internet of Things for a low-power communication as well as LTE, NR and 6G. Here, for example, an NB-IoT technology may be an example of a LPWAN(Low Power Wide Area Network) technology, may be implemented in a standard of LTE Cat NB1 and/or LTE Cat NB2, etc. and is not limited to the above-described name. Additionally or alternatively, a wireless communication technology implemented in a wireless device 100, 200 of the present disclosure may perform a communication based on a LTE-M technology. Here, in an example, a LTE-M technology may be an example of a LPWAN technology and may be referred to a variety of names such as an eMTC (enhanced Machine Type Communication), etc. For example, an LTE-M technology may be implemented in at least any one of various standards including 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M and so on and it is not limited to the above-described name. Additionally or alternatively, a wireless communication technology implemented in a wireless device 100, 200 of the present disclosure may include at least any one of a ZigBee, a Bluetooth and a low power wide area network (LPWAN) considering a low-power communication and it is not limited to the above-described name. In an example, a ZigBee technology may generate PAN(personal area networks) related to a small/low-power digital communication based on a variety of standards such as IEEE 802.15.4, etc. and may be referred to as a variety of names.

### Industrial Availability

A method proposed by the present disclosure is mainly described based on an example applied to 3GPP LTE/LTE-A, 5G system, but may be applied to various wireless communication systems other than the 3GPP LTE/LTE-A, 5G system.

1. A method of receiving a physical downlink control channel (PDCCH) in a wireless communication system, the method performed by a terminal comprising:
receiving, from a base station, configuration information related to one or more control resource sets (CORESETs); and
receiving, from the base station, the PDCCH in the one or more CORESETs,
wherein the configuration information includes information for configuring a quasi co-location (QCL) reference RS (reference signal) for the one or more CORESETs, and
wherein based on PDCCH candidates being configured to be monitored in the same time unit in a first CORESET in which a plurality of QCL reference RSs are configured and a second CORESET in which one or more QCL reference RSs are configured, the PDCCH candidates are monitored in a first CORESET and/or a second CORESET based on a specific number of different QCL reference RSs by the terminal.

2. The method of claim 1, wherein the first CORESET and the second CORESET are configured with different CORESET pool indexes.

3. The method of claim 2, wherein the PDCCH candidates are monitored based on one QCL reference RS among the plurality of QCL reference RSs in the first CORESET, and
wherein the PDCCH candidates are monitored based on one QCL reference RS among the one or more QCL reference RSs in the second CORESET.

4. The method of claim 3, wherein the PDCCH candidates are monitored in the first CORESET based on a QCL reference RS configured by a predetermined transmission configuration indicator (TCI) state among a plurality of TCI states for the first CORESET.

5. The method of claim 4, wherein the predetermined TCI state is a first TCI state or a second TCI state or a TCI state with the lowest TCI state identity or a TCI state with the highest TCI state identity among the plurality of TCI states.

6. The method of claim 2, wherein the PDCCH candidates are monitored based on the plurality of QCL reference RSs only in the first CORESET.

7. The method of claim 2, wherein based on one QCL reference RS being configured in the second CORESET, the PDCCH candidates are monitored based on the one QCL reference RS related to the second CORESET only in the second CORESET.

8. The method of claim 7, wherein the PDCCH candidates are monitored even in a CORESET in which the same CORESET pool index and the same QCL reference RS as the second CORESET are configured.

9. The method of claim 2, wherein based on a plurality of QCL reference RSs being configured in the second CORESET, the PDCCH candidates are monitored based on the plurality of QCL reference RSs related to the second CORESET only in the second CORESET.

10. The method of claim 1, wherein the first CORESET and the second CORESET are configured with the same CORESET pool index.

11. The method of claim 10, wherein the PDCCH candidates are monitored based on one QCL reference RS among the plurality of QCL reference RSs in the first CORESET, and
wherein the PDCCH candidates are monitored based on one QCL reference RS among the one or more QCL reference RSs in the second CORESET.

12. The method of claim 11, wherein the PDCCH candidates are monitored in the first CORESET based on a QCL reference RS configured by a predetermined transmission configuration indicator (TCI) state among a plurality of TCI states for the first CORESET.

13. The method of claim 12, wherein the predetermined TCI state is a first TCI state or a second TCI state or a TCI state with the lowest TCI state identity or a TCI state with the highest TCI state identity among the plurality of TCI states.

14. The method of claim 10, wherein the PDCCH candidates are monitored based on the plurality of QCL reference RSs only in the first CORESET.

15. The method of claim 10, wherein based on one QCL reference RS being configured in the second CORESET, the PDCCH candidates are monitored based on the one QCL reference RS related to the second CORESET only in the second CORESET.

16. The method of claim 15, wherein the PDCCH candidates are monitored even in a CORESET in which the same CORESET pool index and the same QCL reference RS as the second CORESET are configured.

17. The method of claim 10, wherein based on a plurality of QCL reference RSs being configured in the second CORESET, the PDCCH candidates are monitored based on the plurality of QCL reference RSs related to the second CORESET only in the second CORESET.

18. A terminal of receiving a physical downlink control channel (PDCCH) in a wireless communication system, the terminal comprising:
at least one transceiver for transmitting and receiving a wireless signal; and
at least one processor for controlling the at least one transceiver,
wherein the at least one processor configured to:
receive, from a base station, configuration information related to one or more control resource sets (CORESETs); and
receive, from the base station, the PDCCH in the one or more CORESETs,
wherein the configuration information includes information for configuring a quasi co-location (QCL) reference RS (reference signal) for the one or more CORESETs, and
wherein based on PDCCH candidates being configured to be monitored in the same time unit in a first CORESET in which a plurality of QCL reference RSs are configured and a second CORESET in which one or more QCL reference RSs are configured, the PDCCH candidates are monitored in a first CORESET and/or a second CORESET based on a specific number of different QCL reference RSs by the terminal.

19. (canceled)

20. A processing apparatus configured to control a terminal for receiving a physical downlink control channel (PDCCH) in a wireless communication system, the processing apparatus comprising:
at least one processor; and
at least one computer memory operably connected to the at least one processor and storing instructions that, based on being executed by the at least one processor, perform operations comprising:
receiving, from a base station, configuration information related to one or more control resource sets (CORESETs); and
receiving, from the base station, the PDCCH in the one or more CORESETs,
wherein the configuration information includes information for configuring a quasi co-location (QCL) reference RS (reference signal) for the one or more CORESETs, and wherein based on PDCCH candidates being configured to be monitored in the same time unit in a first CORESET in which a plurality of QCL reference RSs are configured and a second CORESET in which one or more QCL reference RSs are configured, the PDCCH candidates are monitored in a first CORESET and/or a second CORESET based on a specific number of different QCL reference RSs by the terminal.

21-22. (canceled)
